(19) United States
(12) Patent Application Publication
(10) Pub. No.: US 2012/0149490 A1
(43) Pub. Date: Jun. 14, 2012

(54) GOLF CLUB SHAFT

(76) Inventor: Jason Swist, Edmonton (CA)

(21) Appl. No.: 13/245,906

(22) Filed: Sep. 27, 2011

Related U.S. Application Data
(60) Provisional application No. 61/420,819, filed on Dec. 8, 2010.
(60) Provisional application No. 61/421,665, filed on Dec. 10, 2010.

(51) Int. Cl. A63B 53/10; B23P 11/00

(52) U.S. Cl. 473/316; 29/428

(57) ABSTRACT

Golf is a massive industry as well as sport globally with golfers investing in continuous evolutions and modifications to golf clubs with sensitivity to weight of a few grams, offset in angle of a degree, “feel” etc. Prior art designs focused to the golf club head, grip, and in a few instances the shaft. However, considerations of accurate alignment between the elements during initial assembly/replacement are not addressed. It is, therefore, desirable to provide a means of assembling a golf club shaft that provides for an accurate alignment between the multiple elements such that alignment between them is established, can be maintained with replacements, and also allows for meaningful adjustments in the grip and head to be achieved as multiple other factors do not confound the desired interpretation of the impact of an adjustment. Accordingly the invention provides for such alignment between multiple elements of a golf club.

### CROSS-REFERENCE TO RELATED APPLICATIONS

This patent application claims the benefit of U.S. Provisional Patent Application U.S. 61/420,819 filed Dec. 8, 2010 entitled “Golf Club Hosel” and U.S. Provisional Patent Application 61/421,665 filed Dec. 10, 2010 entitled “Golf Club Shaft.”

### FIELD OF THE INVENTION

This invention relates to golf clubs and more specifically to golf club shafts.

### BACKGROUND OF THE INVENTION

Golf is a popular game not only in the US but also many parts of the world such as Korea, Japan, India, China, Germany, UK and South Africa. Within the last 5 years, the golf industry has seen a significant growth of 5-15% annually at various regions of the world. According to a recent market study “Opportunities in the Global Golf Club Market 2004-2009” published by E-Composites, Inc., the golf club market in India and China will continue to see a growth rate of over 25% annually for the period 2010-2014. The growing popularity of the game and the general affluence of golfers ensure a substantial market, which in 2010 was estimated US $3.9 billion.

The market for manufacturers of golf clubs/golf shafts is crowded with small to large corporations such as Callaway, Taylormade, Acushnet, Ping Golf and Wilson. There are more than 100 manufacturers of golf clubs around the world and about 50 of these golf clubs/shafts manufacturers are in the USA. Suppliers of golf clubs/shafts are mostly based in the US, China, Taiwan, Korea, Japan, UK, and Germany.

Considering Callaway, one of the industry leaders, then in 2008 sales were divided between woods (24%), irons (27.6%), putters (9.1%), balls (20%), and other accessories (19.3%). With annual revenues of US$1,100 million in 2008 and US$950 million in 2009 woods, irons, and putters together accounted for approximately 60% of their revenue, US$1,230 million for the two years.

Over the years golf club manufacturers have released hundreds of new models featuring variations in the design of many elements of the golf clubs including hosel profile, heel, top line, toe, face, back, back cavity, sole, weighting for the head alone together with introducing steel variations, titanium and carbon fiber materials for the shafts, and weight, geometry, and polymeric materials for the grip that slides onto the upper portion of the shaft. Despite the massive research and development efforts and brand profiles built upon world renowned figures over the past decades such as Tiger Woods, Jack Nicklaus, Greg Norman, Seve Ballesteros, and Fred Couples the fundamental assembly of golf clubs has not changed for a century since the Thomas Horsburgh experimented with steel shafts in the late 1890s.

Essentially a circular shaft has inserted onto one end a grip with a circular inner recess and onto the other end the head with its hosel and circular recess accepting the lower circular end of the shaft. At the same time the golf club industry has amateur and professional golfers spending hundreds of hours practicing and spending $1100s on golf clubs that vary in the angle of the face by a matter of a few degrees. If the club head is “square,” the clubface will be directly facing the target on “address”, if it is “closed,” it will be aligned to the left of the target, and if it is “open,” it will be aligned to the right of the target. It is not unusual for game-improvement clubs (those marketed to higher handicappers and accordingly the significant majority of amateur golfers), particularly drivers, to be marketed as having face angles varying by several degrees as a way to help the golfer fight a sliced drive.

Yet the golfer will then replace the grip either to a design they prefer or to replace a worn grip wherein any notion of alignment between the grip and the club head face is lost. Likewise they will perhaps damage the head and replace it, again destroying any notion of alignment between the grip, shaft and head of the club having spent perhaps hundreds of hours practicing, invested in professional coaching, and investments in the latest and supposedly greatest clubs from a particular manufacturer, typically selected from one of the leading 5 brands. Additionally with modern composites golf club manufacturers can adjust the properties of the golf club shaft parallel and perpendicular to the swing direction wherein misalignments rather than improving the player's performance may negate the performance improvement or even degrade their performance.

Replacement of a golf dub head or shaft typically involves the following steps:

Step 1—Removing the Old Shaft: The old shaft—or whatever is left of it—must be removed from the head. To do this enough heat must be applied to the club head to break down the epoxy bond between the shaft and the head;

Step 2—Cleaning Out the Hosel: Once the shaft is removed, the epoxy residue that is left in the hosel must be cleaned out which is typically through combination of solvents for the epoxy and a file;

Step 3—Preparing Shaft for Installation: First, the manufacturer's recommended tip trimming must be followed, and then the depth of the hosel measured and marked on the shaft. With graphite care should be taken not to splinter it whilst cutting, and with a steel shaft the tip must be abrade to remove the plating.

Step 4—Installing the Shaft: Now the epoxy is mixed, applied to the inside of the hosel and prepared shaft inserted. Then most instructions will say something along the lines of “holding the head in your hand, tap the end of the shaft on the floor until the shaft is seated at the bottom of the hosel.” Now wait for the epoxy to cure.

Step 5—Trimming and Adding Grip: With replacing the shaft one decides how long the finished club is to be, cuts the shaft and installs the grip.

Step 6: Installing the Grip: First double-sided grip tape is applied the length of the grip, wrapping around the shaft. Then grip solvent is poured into the grip and along the entire length of the new grip tape before the grip is slid onto the shaft. Next the user is typically told to set the club in its normal playing position and check that the new grip is on straight. If adjustments need to be made they must be done quickly to twist the grip to achieve the desired alignment before the epoxy cures too far.

During any of these steps a misalignment may occur, and generally will as tooling is typically not designed to address this aspect. As is evident from the prior art, see for example FIGS. 1 to 3, circular geometry golf club shafts, hosels, grips etc dominate the commercial market today and research/development of the manufacturers globally. However, over the years variations have been taught. For example J. Bamber in U.S. Design Pat. Nos. 594,075 and 556,281, both entitled “Golf Club Shaft”, discloses shafts that are triangular in cross-section over the length of the shaft but transition to circular profile for the ends to adapt to the head hosel and grip. Likewise in U.S. Pat. No. 6,561,922 entitled “Golf Club Shaft” Bamber discloses a club shaft that is elliptical in cross-section along its length but that terminates again in a circular cross-section at either end for mating to circular hosel and grip elements. U.S. Pat. No. 5,540,435 by J. Kawasaki teaches to a circular cross-section shaft that contains a tapered element that engages a tapered inner surface of the shaft such that when pulled by action of a threaded element the shaft is mounted to a club with the tapered element and tapered inner surface in interference fit.

J. Cornish in U.S. Pat. No. 5,354,056 teaches to a circular shaft with circular ends with a spiral outer element and C-S You in U.S. Pat. No. 5,976,032 teaches to reinforcing ribs along the length of the otherwise circular cross-section shaft. J. Farina in U.S. Pat. No. 4,537,403 teaches a single piece-part iron with a rectangular cross-section on the shaft. Farina's one piece part design being incompatible with other clubs as well as composite, titanium, and graphite based shafts that form the materials of choice today. R. Perry in U.S. Pat. No. 6,863,618 teaches a club shaft comprising a flat portion along part of its length but is silent to the construction of the hosel and grip and any means of attaching one to the other.

Accordingly within the prior art design effort has focused to the golf club head, grip, and in a few instances, as outlined above, the shaft. However, considerations of accurate alignment between the elements during initial assembly/replacement are not addressed. It is, therefore, desirable to provide a means of assembling a golf club that provides for an alignment between the multiple elements such that alignment between them is established, can be maintained with replacements, and also allows for meaningful adjustments in the grip and head to be achieved as multiple other factors do not confound the desired interpretation of the impact of an adjustment. According to embodiments of the invention such an alignment is provided between the multiple elements of a golf club.

### SUMMARY OF THE INVENTION

It is an object of the present invention to obviate or mitigate at least one disadvantage of the prior art.

In accordance with an embodiment of the invention there is provided a method comprising:
providing a first component of a golf club comprising a first body, a strike face, and a first member comprising at least a first wall and a second wall, the first wall having a predetermined geometry and a first predetermined orientation to the strike face;
providing a second component of the golf club comprising a shaft of length substantially larger than its lateral dimensions, of predetermined cross section, and terminating at one end with a second member, the second member comprising at least a first surface and a second surface, the first surface have a geometry substantially that of the predetermined geometry of the first wall;
engaging the first and second components by aligning the first and second members such that they engage with the first wall and first surface are aligned.

In accordance with another embodiment of the invention there is provided a device comprising a first body, a first outer surface, and a first member comprising at least a first wall and a second wall, the first wall having a predetermined geometry and a predetermined orientation to a predetermined portion of the first outer surface.

In accordance with another embodiment of the invention there is provided a device comprising a first body of length substantially greater than its width or thickness and having a first predetermined cross section, and a member disposed at a first distal end of the first body having a second cross section comprising at least a first wall and a second wall, wherein mating the member with a corresponding recess in another object results in a predetermined relationship between the first wall and an aspect of the other object.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts a method of manufacturing a golf club shaft according to the prior art of Jackson in US Patent Application 2002/0119830;

FIG. 1B depicts a method of manufacturing a golf club shaft according to the prior art of Smith et al in U.S. Pat. No. 6,132,323;

FIG. 1C depicts a method of manufacturing a golf club shaft according to the prior art of Jackson in U.S. Pat. No. 5,788,585;

FIG. 1D depicts a method of manufacturing a golf club shaft according to the prior art of Tennent et al in U.S. Pat. No. 5,265,872;

FIG. 1E depicts methods of manufacturing a golf club shaft according to the prior art of Blough and Renard in U.S. Pat. Nos. 6,845,552 and 5,397,636 respectively;

FIG. 1F depicts a method of manufacturing a golf club shaft according to the prior art of Swinford in U.S. Pat. No. 5,873,793;

FIG. 2 depicts typical golf club shafts according to the prior art and providing decoration according to the prior art of Watanabe in U.S. Pat. No. 5,397,636;

FIG. 3 depicts typical golf grips according to the prior art;

FIG. 4A depicts an embodiment of the invention wherein a golf club head and shaft are aligned through their mating interfaces;

FIG. 4B depicts an embodiment of the invention wherein a golf club shaft and grip are aligned through their mating interfaces;

FIG. 5 depicts an embodiment of the invention wherein a golf club face angle is adjusted with replacement of the shaft in conjunction with a golf club head of a standard external geometry;

FIG. 6 depicts an embodiment of the invention wherein a golf club face angle is adjusted with a variation in the golf club head with respect to a golf club shaft of standard external geometry;

FIG. 7 depicts an embodiment of the invention wherein a golf club grip angle is adjusted with replacement of the shaft in conjunction with a grip of a standard external geometry;

FIG. 8 depicts an embodiment of the invention wherein a golf club grip angle is adjusted with a variation in the golf club grip with respect to a golf club shaft of standard external geometry;

FIG. 9 depicts an embodiment of the invention wherein golf club loft angle is adjusted with replacement of the golf club head with a golf club shaft of a standard external geometry;

FIGS. 10A through 10C depict alternative coupling methods according to embodiments of the invention; and

FIG. 11 depicts an alternate embodiment of the invention employing inserts into the golf club shaft to provide a keyed recess.

### DETAILED DESCRIPTION

The present invention is directed to golf clubs and more particularly to golf club hosels that in combination with aligned golf club shafts provided improved alignment of the assembled golf club.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

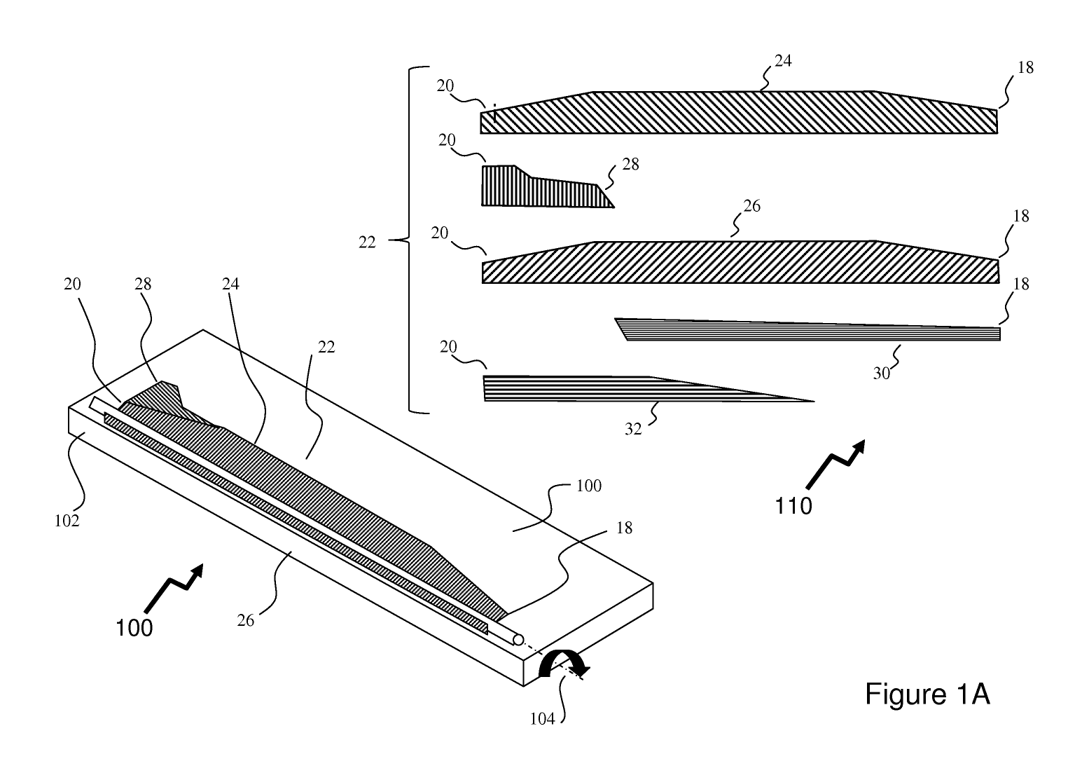

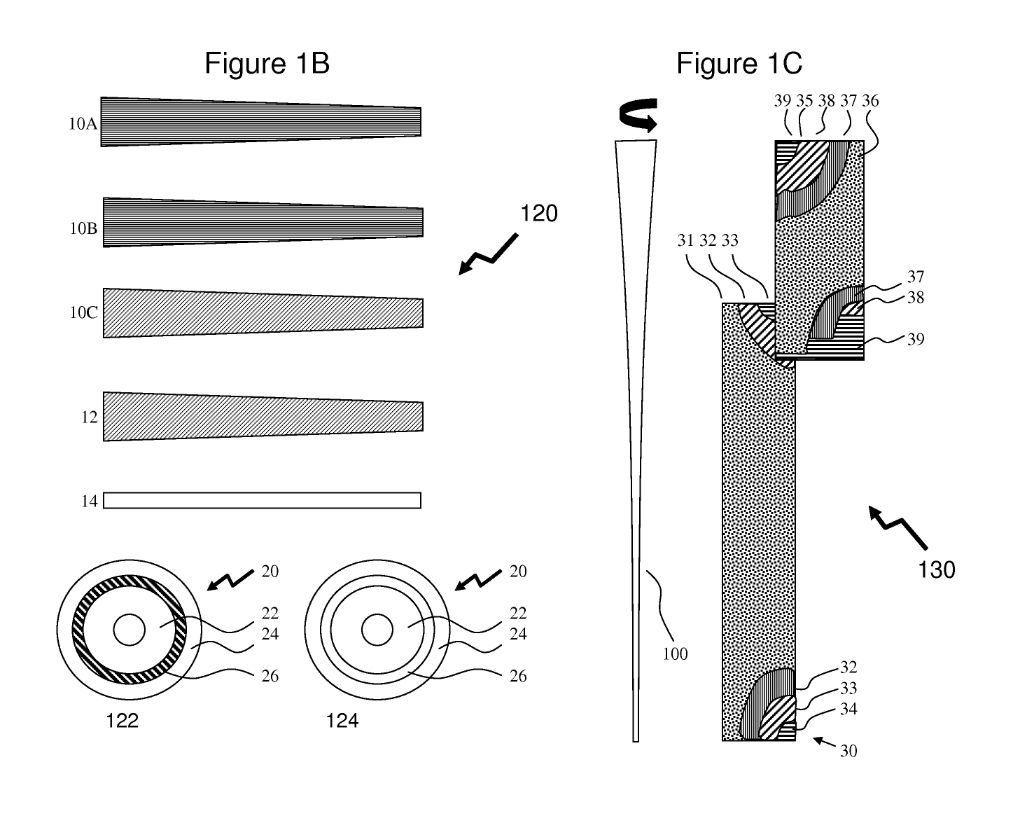

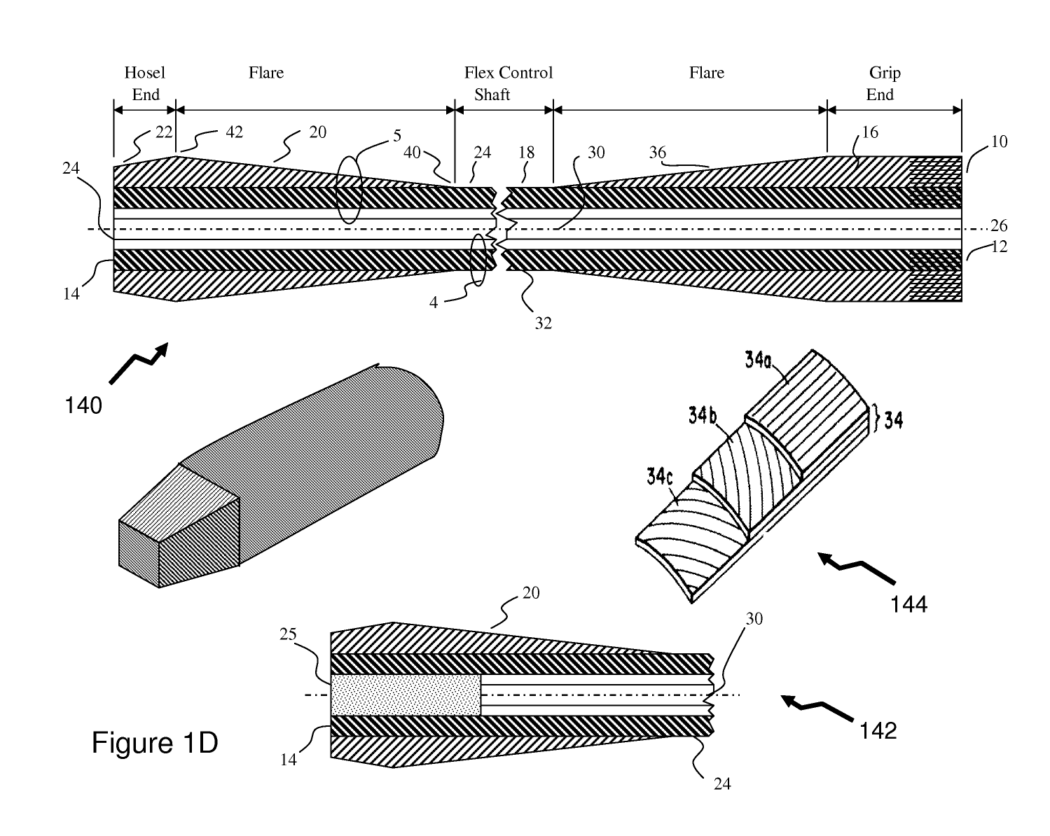

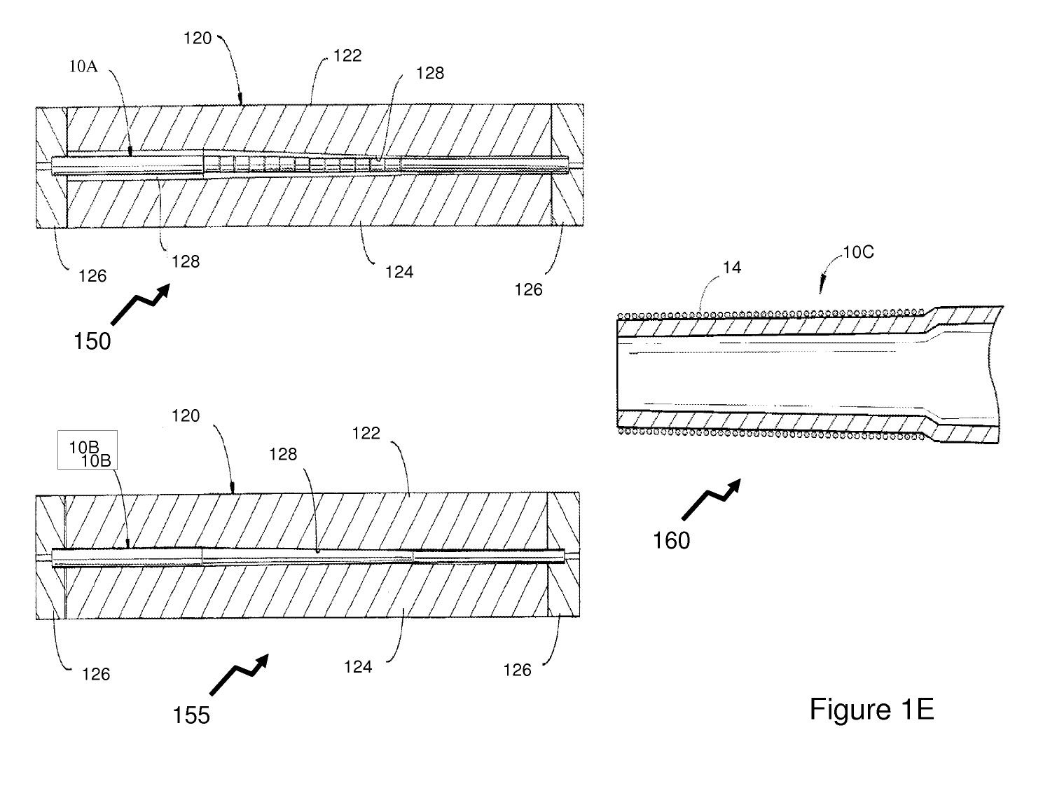

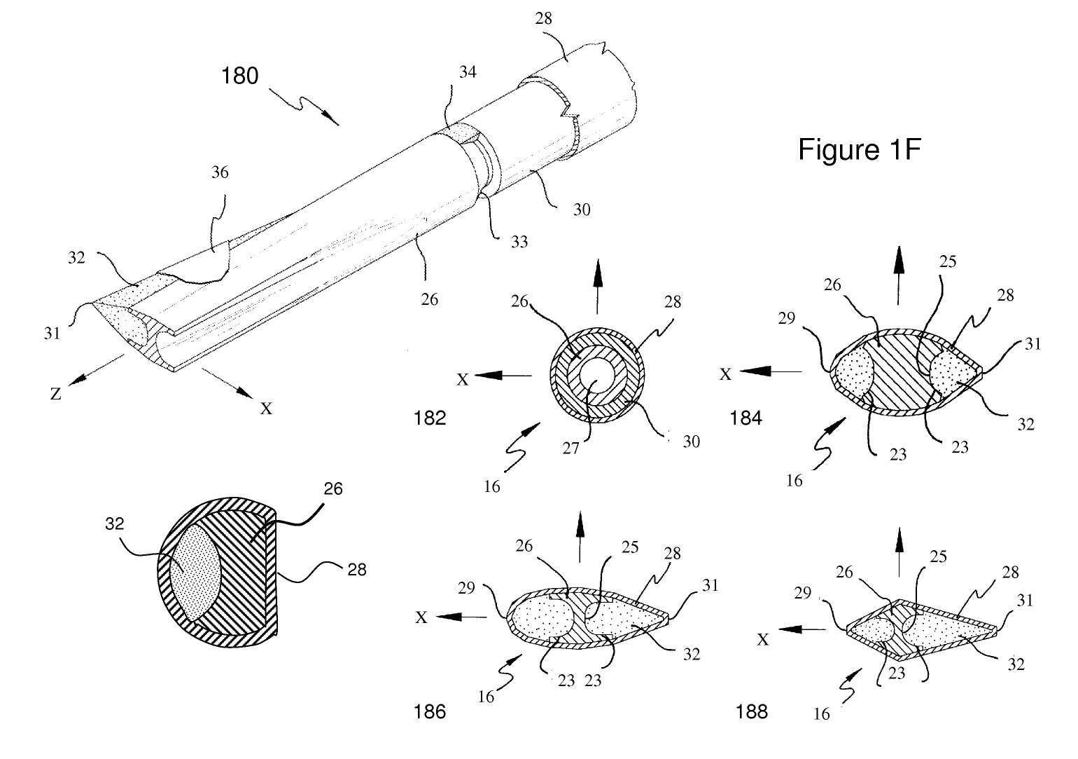

Referring to FIG. 1A there is depicted a method of manufacturing a golf club shaft according to the prior art of Jackson in US Patent Application 2002/0119830 wherein a sub-assembly of plies 22 formed with oriented fibers such as carbon, boron, composite, or metal are shown on a working surface 100. Plies 24 are given the desired shape of a golf club shaft by being rolled onto a mandrel 102, which effectively defines the inner contour of resulting golf club shaft. Additional plies 24 are subsequently positioned and rolled onto the mandrel 102 on top of sub-assembly 22 to form a rolled assembly of plies which is then typically heat-treated to cure and form the golf club shaft. The plies 24 thereby comprising the orientated fibers a matrix within a resin or other material that during the heat treatment will melt to bind each ply 24 to the other plies 24 within the sub-assembly of plies 22.

Mandrel 102 has a tip end and a butt end that corresponds to tip end 18 and butt end 20 of the golf club shaft such that according to the layout of the sub-assembly of plies 22 these are rolled onto the mandrel 102 by rotating in a clockwise or counter-clockwise direction about a longitudinal axis 104 of the golf club shaft. As shown in ply stack 150 the sub-assembly of plies 22 is constructed of first to third plies 24, 26, and 28 respectively, which are shown with their respective tip ends 18 and butt ends 20. First to third plies 24, 26, and 28 are made from pre-impregnated fibers oriented with a bias, referenced transverse to longitudinal axis 104, as shown. For example first ply 24 has an approximate 45-degree bias and second ply 26 has an approximate 135-degree bias and each extends the entire length of the shaft, from tip end 18 to butt end 20. Sandwiched between first and second plies 24 and 26 is third ply 28 which has a 90-degree bias and serves to reinforce butt end 20. Because of the fiber orientation of first to third plies 24, 26, and 28 relative to longitudinal axis 104, these plies are referred to as biased plies.

Positioned on top of biased second ply 26 and aligned with butt end 20 is butt reinforcement third ply 28. The long edge of third ply 28 is offset from a long edge of adjacent second ply 26, typically ranging from approximately ½-1¼ inches. First ply 24 is then placed on top of biased second and third plies 26 and 28 and aligned with both tip end 18 and butt end 20 wherein the long edge of biased first ply 24 is generally not aligned with the long edge of biased second ply 26, the distance separating these edges may for example be 3/16 of an inch and the distance separating the edges of first and second plies 24 and 26 respectively at the butt end 20 is approximately ⅜ of an inch. Construction of golf club shaft typically includes fourth and fifth plies 30 and 32 in addition to sub-assembly 22. Fourth and fifth plies 30 and 32 respectively are substantially shorter in length than biased first and second plies 24 and 26. Oriented with fibers approximately parallel to longitudinal axis 104, the fourth and fifth plies 30 and 32 generally are referred to as longitudinal plies. Longitudinal fourth ply 30 aligns with tip end 18 and longitudinal fifth ply 32 aligns with butt end 20. Longitudinal fourth and fifth plies 30 and 32 respectively may overlap each other according to the exact design of the golf club shaft. Fifth ply 32 typically is offset from plies 24, 26, and 30, which align with an initial position of rotation on mandrel 102, instead fifth ply 32 aligns with a 180-degree position of rotation on mandrel 102.

It would be apparent to one skilled in the art that the angle of the fibers of biased first ply 24 may range from approximately 25 degrees to 65 degrees transverse to longitudinal axis 104, while the angle of the fibers of biased second ply 26 may range from approximately 115 degrees to 155 degrees transverse to longitudinal axis 104. Generally, the fibers of second ply 26 create a supplementary angle to the fiber angle of first ply 24, with respect to longitudinal axis 104. The angle of the fibers of butt reinforcement third ply 28 may range from approximately 80 degrees to 100 degrees transverse to longitudinal axis 104. The angle of the fibers of longitudinal plies 30 and 32 generally range from approximately 10 degrees to −10 degrees transverse to longitudinal axis 104.

Now referring to FIG. 1B there is depicted a method of manufacturing a golf club shaft according to the prior art of Smith et al in U.S. Pat. No. 6,132,323 employing a set of plies of pre-impregnated (pre-preg) carbon fiber sheet 10 and adhesive 12. As shown in exploded assembly 120 pre-preg plies 10a and 10b comprise carbon fiber bound within a thermoplastic resin, and pre-preg ply 10c comprises carbon fiber bound within a thermosetting resin. Those skilled in the art will appreciate that in alternative forms different composite materials, such as glass fiber, might be used, and that the use of such materials would be an equivalent substitution of components. In the embodiments described herein and shown the ply/plies of pre-preg including the thermoset resin is/are preferably oriented at +/−45°, and the ply/plies of pre-preg including the thermoplastic resin is/are oriented at 0°. However, those skilled in the art will appreciate that, depending upon the design characteristics desired for a particular shaft, additional layers of fiber or pre-preg may be utilized, and the orientation of the layers of fiber or pre-preg may be varied.

The pre-preg carbon fiber sheets comprising plies 10a-c may be manufactured by pulling strands of carbon fiber, or a fabric or weave of carbon fiber, through a resin solution and allowing the resin to partially cure. Moreover, when the resin is partially cured, the resin holds the fibers together such that the fibers form a malleable sheet. The steps that may be followed in manufacturing a golf club shaft in accordance with the present invention may proceed, for example, as follows. The dimensions and relative positions of the plies of pre-preg carbon fiber 10 and adhesive 12 are determined, and a set of plies 10a-c and 12 to be used within the shaft are prepared. A mandrel 14 having predefined dimensions is selected and covered by a bladder (not shown). The bladder may be formed, for example, from latex, rubber or silicone. The plies 10a and 10b (i.e. the plies including the thermoplastic resin) are then wrapped around the bladder-covered mandrel 14 in a predetermined manner, and pre-cured. Thereafter, the ply of adhesive 12 may be wrapped over the pre-cured layers of thermoplastic pre-preg, and the ply 10c (or plies, if desired) of thermoset pre-preg may be wrapped over the adhesive 12. After the various plies 10a-c and 12 are wrapped around the mandrel 14 in the prescribed manner, a cellophane or polypropylene tape (or other shrink wrapping material) may be wrapped around the outermost layer of pre-preg, and the wrapped mandrel assembly may be placed in a mold and heated for a time sufficient to allow the plies of pre-preg comprising the golf club shaft to fully cure.

Following this process, the part may be removed from the mold, the shrink-wrapping material may be removed from the part, and the exterior surface of the part may be sanded and finished to specifications of the manufacturer or golfer. Those skilled in the art will appreciate that, depending upon the type of resin used, oven temperatures may range from 250° to 800° F., the requisite curing time may range from a few minutes (for example, in the case of “quick cure” epoxy or thermoplastic resins) to several hours, and the pressure applied via the latex bladder may range from 0 psi (for some thermoplastic resins) to 1,000 psi. Thus, during the pre-curing phase the oven temperature will be set to that applicable to the plies to be pre-cured, and during the final curing stage, the oven will be set to the temperature applicable to the uncured plies.

Alternatively, one or more plies of pre-preg including a thermoset resin may be wrapped around a first mandrel and pre-cured to form a shell structure. Thereafter, the mandrel may be removed, and a plurality of plies of pre-preg including a thermoplastic resin may be wrapped around a second, bladder covered mandrel, a layer of adhesive may be wrapped over the plies of thermoplastic pre-preg, and the plies of thermoplastic pre-preg and adhesive may be inserted into the shell formed by the ply (or plies) of thermoset pre-preg. Finally, the wrapped mandrel and shell assembly may be placed in a mold, the bladder may be inflated to a predetermined pressure, and the mold may be heated to a predetermined temperature and for a time sufficient to allow curing of all of the plies of pre-preg comprising the golf club shaft. As explained above, the ply/plies of pre-preg including the thermoset resin is/are preferably oriented at +/−45°, and the ply/plies of pre-preg including the thermoplastic resin is/are oriented at 0°.

However, those skilled in the art will appreciate that, depending upon the design characteristics desired for a particular shaft, additional layers of fiber or pre-preg may be utilized, and the orientation of the layers of fiber or pre-preg may be varied. Further, it will be appreciated that filament winding processes also may be utilized to produce golf club shafts in accordance with the present invention. In such embodiments, it may be desirable to filament wind strands of nylon with graphite reinforced thermoplastic pre-preg onto a mandrel in a +/−45° orientation, and to pre-cure the resulting structure. Thereafter, a layer of adhesive may be wrapped over the pre-cured fiber layer, and one or more plies of pre-preg staged within a thermoset resin may be wrapped over the adhesive layer. Preferably, the plies of thermoset pre-preg are aligned in a 0° orientation. Finally, the wrapped mandrel assembly may be wrapped with a cellophane or polypropylene tape, placed in a mold, and heated to a predetermined temperature for a time sufficient to allow the various layers of composite to fully cure.

Referring to first shaft 122 a golf club shaft in accordance with the invention described above in respect of exploded assembly 120 is shown comprising a shaft wall structure 20 including a plurality of layers 22 comprising composite fiber fixed within a first thermoplastic resin binding matrix, one or more layers 24 of composite fiber fixed within a second thermoset binding matrix and at least one layer 26 comprising an adhesive, wherein the adhesive upon curing provides a bond between the layers of composite fixed within the thermoplastic and thermoset binding matrices. Further, those skilled in the art will appreciate that, while it is presently preferred that the layer(s) of composite including the thermoset binding matrix encase or surround the layers of composite including the thermoplastic binding matrix, the order of the layers may readily be reversed, as shown in second shaft 124. Additionally, it would also be understood by one of skill in the art that the methods of the present invention may be utilized to form sections of a golf club shaft and that neither the thermoset nor thermoplastic layers of composite need necessarily extend along the entire length of the golf club shaft. Further as will be evident from alternative constructions presented below these layers of composite may be increased to form a substantially thicker or sold end to the golf club shaft where the shaft will engage the hosel of the golf club head or grip.

Now referring to FIG. 1C there is depicted another method of manufacturing a golf club shaft according to the prior art of Jackson in U.S. Pat. No. 5,788,585 with assembly view 130. In this alternate manufacturing method a shaft 10 is formed from a composite material including a plurality of laminar sheet material-type plies that are formed of flexible fibers. Such fibers may include for example boron, tungsten, iron or carbon in the form of graphite. For example, the material may comprise graphite-based, binder-containing, heat-settable fibers formed into a sheet with a predefined, uniform orientation of the fibers in the sheet. Such a sheet optimally may be oriented relative to the long axis of shaft 10 to orient the fibers contained in the sheet to provide the desired structural characteristics for shaft 10. The selective orientation of the fibers in the material in the preferred embodiment is shown in assembly view 130 showing the material in layered sheets or plies, before it is formed into the shaft shape of shaft 10. It will be seen that the plies are grouped into two discrete segments. The plies may be characterized by the orientation or bias of the fibers in the plies, relative to the longitudinal axis of the plies. Those plies in which the fibers are aligned with the longitudinal axis are referred to herein as longitudinally oriented plies, and those plies in which the fibers extend at an angle to the longitudinal axis are referred to as angularly oriented or biased plies.

Generally the plies alternate between angularly biased fibers and longitudinally oriented (unbiased) fibers. For example, in a first segment 30, shown in the lower portion of assembly view 30, the plies include an angularly biased ply 31, an adjacent longitudinally oriented ply 32, another angularly biased ply 33 adjacent ply 32, and finally another longitudinally oriented ply 34. It will be seen that the fibers in angularly biased plies 31 and 33 are shown at mirrored angles to each other. The preferred angle of plies 31 and 33 is approximately 45-degrees to the longitudinal axes of the plies, which also means that the fibers in ply 31 are perpendicular to the fibers in ply 33. A similar fiber arrangement is found in a second segment 35. Thus, the plies include an angularly biased ply 36, a longitudinally oriented ply 37, another angularly biased ply 38, and another longitudinally oriented ply 39. Longitudinally oriented ply 37 is immediately intermediate angularly biased plies 36 and 38. The fibers in angularly biased plies 36 and 38 are mirrored similar to plies 31 and 33, but the angular bias is such that the fibers are oriented at approximately a 60-degree angle to the longitudinal axes of the plies. This means that the fibers in plies 31 and 33 are closer to alignment with the longitudinal axes of the plies than are the fibers in plies 36 and 38. When the plies are formed into a finished shaft, as described below, it will be seen that the longitudinal axes of the plies is axially oriented relative to the shaft.

By dividing all of the plies of the composite material into two discrete segments of substantially continuous fibers, as opposed to continuous fibers running substantially the entire length of shaft 10, the resulting golf club shaft 10 may be perceived by many golfers to be more responsive than a conventional club with improved resistance to flexure and torsion. Segments 30 and 35 are rolled into a finished shaft having a laminar structure shown wherein the thickness of the plies and segments once assembled rather than giving a stepped structure to the shaft in reality smoothly tapers from one segment to the other as the plies are very thin.

An alternate method of manufacturing a golf club shaft according to the prior art of Tennent et al in U.S. Pat. No. 5,265,872 is shown in FIG. 1D. Unlike the shaft of the present invention described above in respect of FIGS. 1A to 1C this golf club shaft has what may be termed a “modified hour glass” shape. The shaft 10 as shown comprises five sections, which as designated from the top or upper (grip) end 12 to the bottom or lower (club head) end 14 of the shaft are respectively the grip section 16, the lower flare section 20, the flex control section 18, the upper flare section 36 and the hosel section 22. While these sections represent slightly different structures physically, it will be understood they are all part of the unitary shaft and that there are no abrupt physical joints between the sections. The sections are designated herein for ease in referring to the different regions of the structure of the present shaft 10, rather than to imply that the shaft 10 itself is formed of separate components which must be joined. It would be evident to one skilled in the art that the number of sections may be increased or decreased according to the complexity of the design, desired performance of the golf club shaft.

The substrate of the shaft 10 is base rod 24, which extends for the length of the shaft 10, which is an elongated rod formed about axial centerline 26. It is, as shown in cross-section 140, hollow throughout its length but if desired (as for weight distribution) either or both the upper and lower portions of the rod 24 may be solid as indicated in section 142. The solid lower portion will start at the lower end 14 but should not extend into the flex control section 18 since such would adversely affect the flex, stiffness and torque of the shaft 10. The base rod 24 of the shaft 10 will typically have a slight taper throughout its length, since the interior hollow space 30 should have such a taper to permit withdrawal from the mandrel on which it is formed. The base rod 24 is formed by wrapping successive layers of fiber-reinforced composites until the desired thickness of wall 32 is obtained. Typically a shaft may have 5-25 layers or plies 34 of composites; 10-20 layers being common. As shown in schematic detail 144, each successive ply 34 (here designated 34a, 34b and 34c) will normally be laid up in manufacturing so that the orientation of the fiber reinforcement in one layer or ply 34 is at a marked angle to the orientation of the fibers in each of the immediately adjacent layers 34. Typically the angular difference is 30°-90°, although other angular differences may be used. It is also desirable in some cases for successive layers to have parallel orientation, such as the outer layers of the shaft.

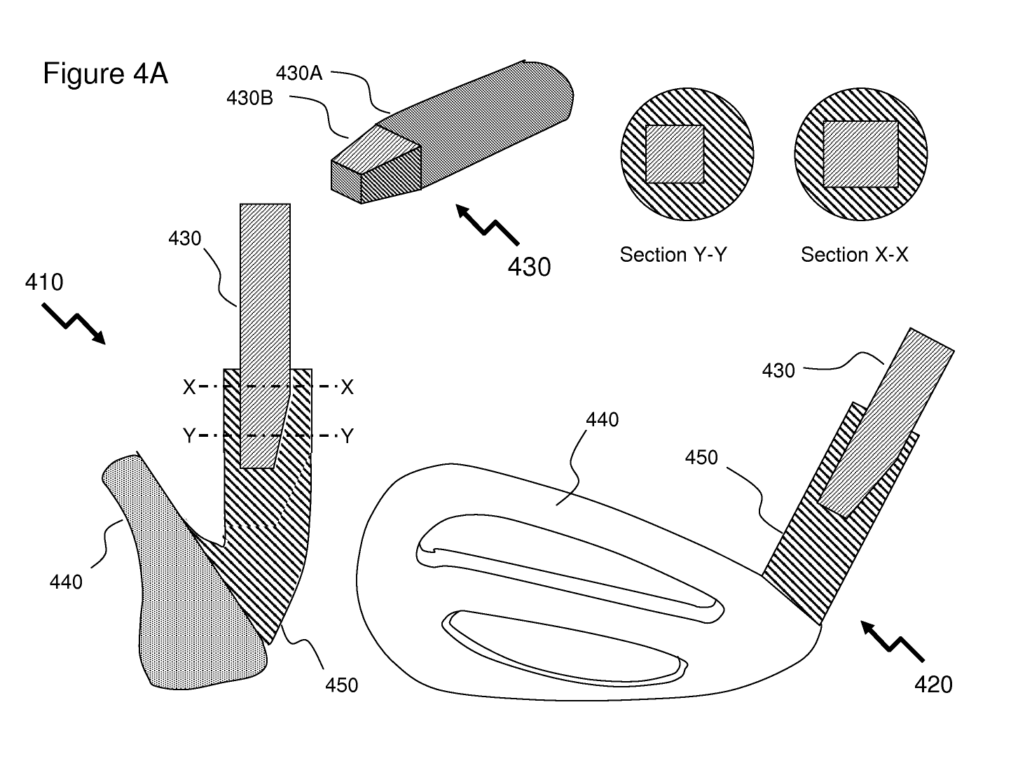

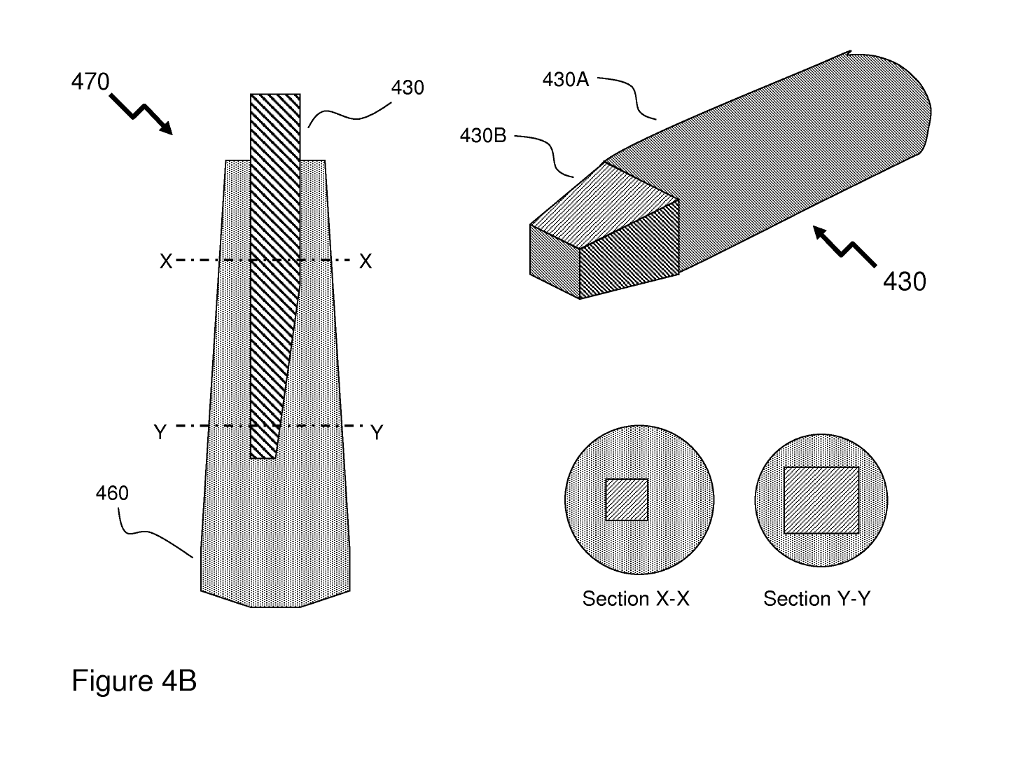

The average outside diameter of the base rod 24 will be on the order of about 0.375″ (1 cm) near the middle of the shaft 10, with a wall 32 thickness of about 0.1″ (2.5 mm). It will be recognized that the axial taper of the base rod 24 will result in a slightly greater outside diameter at the upper end 12 and a slightly lesser diameter at the lower end 14, although wall 32 thickness will generally be constant throughout. Average diameter and/or wall thickness may be varied if desired for a thicker or thinner shaft. As shown in cross-section 140 the base rod 24 itself principally makes up flex control section 18. Few additional over-wrapping layers are applied to the base rod 24 in this section, and then usually only near the upper end (although there will normally be surface coatings as described below). All of the other sections are then formed by applying over-wrapped layers or plies 34 to the outer surface of base rod 24 so that they will have greater average diameters than that of flex control section 18. Above the flex control section 18 is the grip section 16, which extends to and abuts the upper flare section 36 and continues to the top end 12 of the shaft as either a constant diameter or may have a tapered outer surface parallel to the outer surface of the base rod 24. This permits a club grip to be fitted over the grip section 16 and adhered thereto, as shown in FIG. 4B below. The maximum diameter of grip section 16 is limited by the maximum outer diameter of the grip which must have a diameter large enough, but not too large, to enable a player to comfortably hold and swing the club in the normal manner. Commonly the maximum outer diameter of the grip section 16 will be on the order of about 0.1″ to 0.2″ (2.5-5.0 mm) greater than the average outer diameter of the base rod 24. Most players' hands are of similar sizes, and the standard outer sizes of golf club grips are well known and need not be detailed here.

Now referring to FIG. 1E there are shown aspects of manufacturing a golf club shaft according to the prior art of Blough, Renard and Watanabe in U.S. Pat. Nos. 6,845,552; 6,139,444; and 5,397,636 respectively. Referring first to pre- and post-molding schematics 150 and 155 respectively then in pre-molding schematic 150 there is shown a tube 10A depicted that is step formed to be formed into shaft 10B. The step pattern is formed onto tube 10A by holding the grip end of the shaft rigidly, and pushing the opposite end of the tube, which will become the tip section of the s shaft, axially through one of more cylindrical dies, the inside diameter of which are less than the grip end diameter. The tube is pushed sufficiently far through each die such that the shaft obtains the appropriate diameter of each point along its length. Desirably, the grip end outside diameter is equal to, or slightly smaller than the inside diameter at or near the corresponding grip end of the hydroform mold, and the tip end outside diameter of the shaft is equal to or slightly smaller than the inside diameter at or near the tip end of the hydroform mold. That is, the shaft, before hydroforming, has section(s) with outer diameter(s) or dimensions which are generally at least about 50% desirably about 60%, 75%, or 85%, and preferably at least about 87% or 90% of the corresponding inner diameter dimensions of the female hydroform mold.

The shaft is subsequently hydroformed in a hydroforming apparatus as described in U.S. Pat. No. 6,014,879 entitled “High Pressure Hydroforming Press” by Jaekel et al. The process entails placing the tube 10A into one half of the female hydroform mold. The halves of the hydroform mold 122, 124 comprise a mold cavity 128 of one of more machined sections which are individually contoured to produce a desired shaft. Generally one of the mold halves is mounted on a moveable slide that allows the mold to be moved for shaft loading and unloading. The apparatus contains a mold portion which is carried by a platen driven up and down vertically by hydraulic cylinders. After a tube is placed on the slidable mold section, the assembly is moved horizontally into position under the opposite mold section. The platen carrying the mold section is then hydraulically driven down into contact with the lower mold section by low-pressure hydroforming fluid.

Once the upper and lower mold sections are in position, the tube-end engaging structures 126, or high-pressure end closures seal opposite ends of the shaft in the assembled hydroform mold. Hydroforming fluid, such as but not limited to water, or a water mixture, is first introduced into the tube blank by a low pressure centrifugal pump. Once the tube blank and platen hydraulic cylinders have reached the equilibrium pressure of the low pressure pump, typically 70-90 psi, they are further pressurized by an air over hydraulic intensifier pump (or pumps) to further pressurize the interior of the tube blank. As the internal pressure in the tube exceeds the materials yield strength, generally pressure great enough to exceed the yield strength of the material being formed or from about 10,000 psi to about 50,000 psi, although typically between 15,000 psi and 20,000 psi, the tube blank expands. Expansion continues until the blank material contacts and substantially conforms to the shape of the inner surface of the hydroform mold wherein it becomes the shaft 10B.

The tube is pressurized to a preset pressure or for a preset length of time, which depends at least in part to the material utilized. Once these parameters are met, the pressure is removed from inside the tube, and from the hydraulic platen cylinder. The tube-end engaging structures are disengaged from the mold, and the mold platen is raised. The slidable mold section is then moved to the unload position and the expanded shaft removed from the mold cavity. After the shaft has been hydroformed it can be cut to a desired length for the club being formed. Furthermore, additional processing steps to impart necessary strength and cosmetic appearance to the shaft such as but not limited to heat treating, polishing, and plating, can be performed depending on the metal or metal matrix composite utilized as known to those skilled in the art.

Importantly, the hydroform mold can be designed with a variety of configurations to produce a golf club shaft which alternatively can enhance club feel, performance, or aesthetic design. The hydroforming process is capable of producing current industry standard constant taper and step shafts, but also allows for non-progressive or variable inner and/or outer diameter changes other than a step change throughout the length of the shaft. That is, at least one portion of the inner diameter can have any number of shapes such as sinusoidal, curvilinear, concave, convex, etc., linear tapered inward or outward, and the like. While generally not varied as often, at least one portion of the outer diameter can have any number of the shapes just noted. Moreover, the wall thickness of the shaft can vary in at least one portion from thinner to thicker, from thicker to thinner, and the like. Shafts thus can be created which include features or ornamental designs, such as but not limited to hour glass shapes, bubble shapes, multiple protrusions, indentations, flutes, grooves, and/or ridges that can be added at any point along the shaft. Performance enhancing grooves and ridges can be oriented at any angle on the shaft from annular rings to bias lines, to parallel lines. Geometric or arbitrary patterns, logos, trademarks, symbols, quality markings, manufacturing names, etc., can also be formed on or in the shaft during the molding process . . . .

Referring to alternate shaft 10C which utilizes a tubular metallic sheath 14 comprising a grid or cloth. The sheath 14 may comprise metallic wires arranged at an angle with respect to the longitudinal axis of the shaft 10C. The sheath 14′ may utilize nonmetallic wires or fibers in a meshed relationship with metallic wires. Depending upon the number and orientation of the metallic wires, the shaft 10C can have mechanical characteristics similar to that of the shaft 10 utilizing the resulting metal tube 14 that is formed during the hydrostatic molding process.

Now referring to FIG. 1F there is depicted a method of manufacturing a golf club shaft according to the prior art of Swinford in U.S. Pat. No. 5,873,793. A partly sectional, perspective view of the transitional region of a streamlined shaft 16 is depicted in perspective section 180. The skin 28 is partially removed from the shaft 16 exposing the spar 26, core 32, tube 30, filler material 34, and a thin film 36. The portion of the core 32 opposite the trailing edge 31 (the leading edge portion) of the streamlined shaft 16 is not shown in order to illustrate the transitional shape of the spar 26. The filler material 34 is partially removed in order to illustrate the void created by the tapered annular surface 33 of the spar 26 and the end of the tube 30. The thin film 36, described in greater detail later, is partially removed from the spar 26 and core 32 for clarity.

A golf club shaft according to the design approach shown in perspective section 180 may use a blend of high and low modulus composite materials and metallic materials. It is necessary to have a high value for the longitudinal Young's modulus of the spar 26 in order for it to restore bending properties about the X axis of the shaft 16, one such material being a uni-axial filament aligned graphite/epoxy composite wherein the filaments are aligned in the Z direction of the shaft 16. Such composites can exhibit extremely high modulus of 200 Gpa and above. A method of manufacture of the spar 26 is to press uni-axially orientated filaments and resin binder into near net shape, using dies under high pressure. This part is then cured, removed from the dies, and machined to length wherein the recessed surfaces 23 of the spar 26 are formed to the net shape. Excess material would be orientated in the areas which will later be machined away, forming the surfaces of the spar 26 contacting the skin 28. Due to the faceted nature of the streamlined region of the shaft 16, complex machining of the surfaces of the spar 26 is minimized.

An alternate method of manufacturing the spar 26 is to machine from solid composite bar stock which may be less desirable due to the anticipated operation time. If it is impractical to manufacture the spar 26 by the above methods, the spar 26 may be made from an alternate homogeneous material. Alternate materials for the spar 26 include titanium or steel, with Young's modulus equal to approximately 100 GPa and 200 GPa respectively. Both would offer lower modulus and increased weight over some graphite composites, however, forming the spar 26 from these materials may offer an advantage over composites in terms of cost, complexity of cross-section, or transitions in cross-section design for example between the main shaft length and the short sections that engage the golf club head hosel and grip. The spar 26 if constructed from these materials could be forged, cast, or powder sintered to near net shape, requiring little or no post-machining. The density of these alternate materials may limit the practical length of the streamlined section of the shaft 16 wherein a maximum weight limit is encountered.

The tube 30 may be constructed with a filament winding process such as described above in respect of FIGS. 1A through 1D, whereby fibers pre-impregnated with a resin binder are wrapped around a temporary mandrel at a predetermined angle. The material for the tube 30 would preferably be a high modulus composite, such as the graphite/epoxy candidates previously described. In lieu of a composite material, the tube 30 could be constructed from drawn metallic tubing, such as steel or titanium. At the expense of increased weight, the use of a metallic tube 30 could offer the advantage of reduced manufacturing time by eliminating the necessity for a temporary mandrel, since the tube 30 would not be filament wound. Additionally, it may be easier to join the tube 30 to the spar 26 by brazing, welding, swaging, or fastening.

Whilst tube 30 is depicted as circular it would be evident to one skilled in the art that the tube 30 may be square, polygonal, or other alternate configurations. The skin 28 may also be constructed in a conventional filament winding process, however, as opposed to the tube 30 which may use a temporary mandrel during filament winding, the skin 28 could be constructed by wrapping a fibrous resin impregnated material at a predetermined angle directly over the spar 26, tube 30, core 32, filler material 34, and thin film 36. The material for the skin 28 would preferably be a lower modulus composite, such as S-glass/epoxy, in order to minimize its contribution to shaft stiffness about the Y axis in the fully streamlined region. It may not be necessary to filament wind material forming the skin 28 along the entire length of the shaft 16. However, filamentary material forming the skin 28 could at least be wrapped from the tip of the shaft 16 to a distance along the shaft 16 at which the spar 26 is cylindrical in cross-section, in order to create the previously mentioned structural joint. The skin 28 has a nearly constant wall thickness for simplicity; however, the wrap angle of the filaments forming the skin 28 may vary from the cylindrical portion to the streamlined portion of the shaft 16.

An alternate method of manufacturing the skin 28 would be to injection mold two plastic halves which are mirrored copies of each other. These halves would then be bonded to the spar 26 and core 32 using a structural adhesive. The material utilized for the core 32 for weight considerations could be a foam, such as polystyrene or Styrofoam™. The foam would ideally be molded around the spar 26 in order to minimize final shaping. An alternate material which could be employed is balsa wood. The disadvantage with using this material would be the increased work required to shape the core 32. The core in the vicinity of the streamlined skin using these materials would have a low density, for example 2.0 kg/dm³.

During filament winding of the skin 28, a high level of pressure may be exerted on the relatively sharp trailing edge 31 of the streamlined region of the shaft 16. This might cause the filament tow to dig into the core 32 instead of laying on the surface. Therefore, it may be necessary to apply the previously mentioned thin film 36 over the exterior of the streamlined portion of the shaft 16 prior to filament winding of the skin 28, thereby increasing the bearing strength of the core 32. This film 36 may take the form of a spray or dipped epoxy-like coating, a heat-shrunk plastic such Mylar™. If the previously mentioned films do not provide adequate core 32 bearing strength for filament winding, a temporary core 32 may be affixed to the spar 26. This temporary core 32 could be in the form of a hard wax for example. Once filament winding of the skin 28 is complete, the temporary core 32 could be removed by raising its melting temperature during the curing of the skin 28, or subsequent to this step. A permanent foam core 32 could then be injected into the cavities of the shaft 16, or if the skin 28 possesses sufficient transverse compressive strength, omitted entirely.

First cross-section 182 is a cross-sectional view of a shaft 16 manufactured according to this embodiment of the invention wherein the shaft 16 has a spar 26, a skin 28, and a tube 30, each having circular cross-sections. The tube 30 ending at a position wherein the structure changes to one with the non-circular geometry and in this region the spar 26 and skin 28 are separated from on another by the interior and exterior surfaces of the tube 30. Additionally, the interior portion of the spar 26 defines a cavity 27 with a circular cross-section. In second cross-section 184 there is a cross-sectional view of the shaft 16 taken along a cutting plane that represents the shaft 16 as it has midway transitioned from a circular shape to a non-circular, in this case streamlined shape. The shaft 16 embodies a leading edge 29 and a trailing edge 31. In this vicinity, the skin 28 is in direct contact with a portion of the spar 26 and a core 32. The core 32 provides shape during filament winding of the skin 28. The core 32 is divided into two parts within the interior of the skin 28, a first portion in the region of the leading edge 29 of the shaft 16, and a second portion in the region of the trailing edge 31. Division of the two portions of the core 32 is due to the web of the spar 26. The spar 26 depicted in second cross-sections 184 is midway transitioned from a circular cross-sectional shape to an I-beam like shape. The spar 26 may have a recessed surface 23 generally mirrored about the Y axis of the cross-section, forming a web 25. In this vicinity, the spar 26 introduces a slightly greater moment of inertia about the X axis than about the Y axis, due to the recessed surfaces 23. This is necessary to counteract the skin 28 which has slightly greater moment of inertia properties about the Y axis than about the X axis.

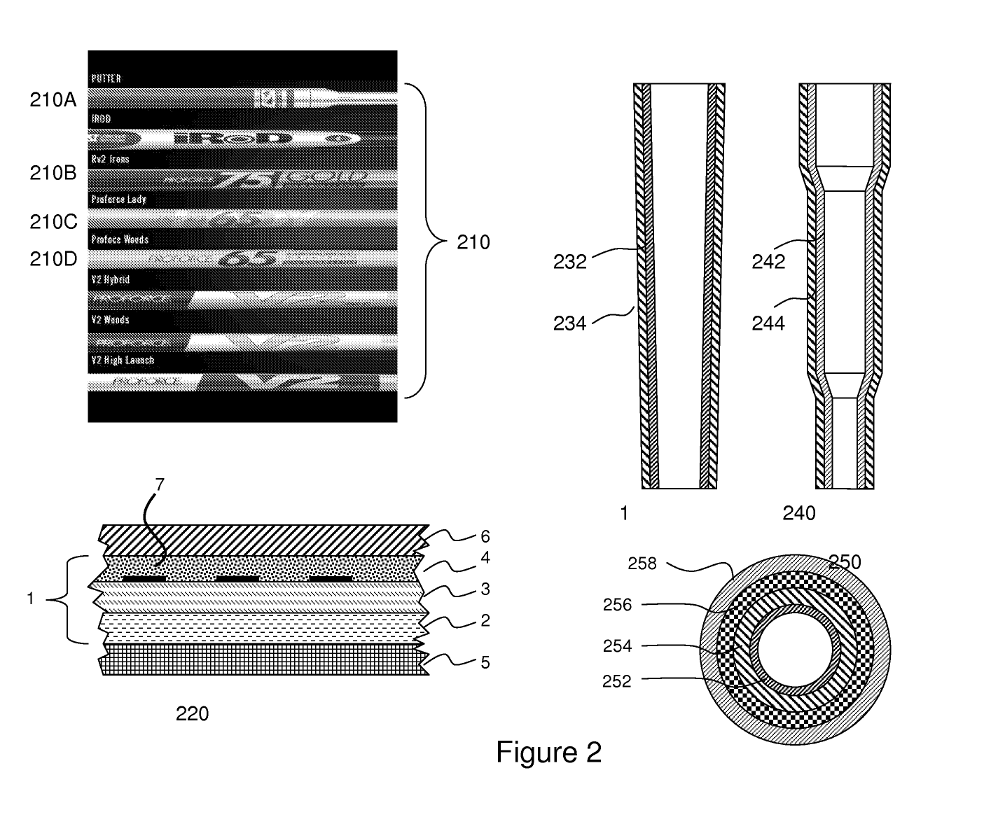

Now referring to third cross-section 186 taken along cutting plane of the shaft 26 representing that of an approximated airfoil composed of many facet-like edges, representing the cross-section in the non-circular region. It would be evident to one skilled in the art that this non-circular region may be of many designs such as described below in respect of embodiments of the invention in FIGS. 2 through 10. For example fourth cross-section 188 depicts an alternate embodiment of the present invention. In this embodiment the shaft's cross-sectional shape is an approximated airfoil with exactly six (6) facet-like edges, forming a diamond-like shape. In each of third and fourth cross-sections 186 and 188 respectively the shaft 16 has a cross-section which has fully transitioned to a shape that provides a single orientation for inserting the shaft to a corresponding recess on a golf club hosel or grip. The facet-like shapes offer reduced machining complexity of the core 32 and spar 26 prior to filament winding of the skin 28.

Referring to FIG. 2 there are depicted typical golf club shafts 210 of graphite from one manufacturer UST Mamiya wherein 8 different shafts are presented. These include first to fourth shafts 210A through 210D which are targeted to putters, irons, women, and woods respectively. It can be seen that these golf club shafts 210 have graphics which can include manufacturer's trademarks, product branding, as well as cosmetic effects. Within the preceding embodiments hybrid laminated pre-preg layers have been employed in forming a golf-club shaft either completely or partially such as skin 28 in FIG. 1F. It would be evident to one skilled in the art that such pre-preg layers can provide the mechanism for providing these graphical elements of the finished golf club shaft. As shown in laminate cross-section 220 according to an embodiment of the invention after Watanabe in U.S. Pat. No. 5,397,636 which comprises a resin layer 2, a decorative layer 3 laminated thereon, and a transparent fiber reinforced composite resin layer, i.e., transparent pre-preg layer 4, laminated on the decorative layer 3. This hybrid laminated pre-preg 1 is used in combination with the pre-preg layers discussed supra to produce a fiber reinforced composite resin material molding such that it is laminated as the outermost layer of a lamination of pre-preg layers wound for lamination on a mandrel or the like, the decorative layer 3 thus providing an aesthetic sense of appearance to the molding obtained by hardening the overall pre-pregs. The whole hybrid laminated pre-preg 1 is supported on a releasing paper 5, on which the innermost resin layer 2 is laminated. A transparent cover film 6 is laminated on the outer transparent pre-preg layer 4, if desired. The releasing paper 5 and a cover film 6 are removed when the hybrid laminated pre-preg 1 is used.

The resin layer 2 provides for adhesion of the hybrid pre-preg 1 to the outermost layer of the usual pre-preg lamination, on which the pre-preg 1 is laminated. As the resin layer 2 may be used thermosetting epoxy resins or like usual matrix resins used for usual pre-pregs. The resin layer 2 is usually transparent but may not be transparent. The weight of the resin layer 2 on the releasing paper 5 is typically between 5 to 200 g/m2. The decorative layer 3 serves to impart the molding with an aesthetic sense of appearance, and it has a pattern 7. The decorative layer 3 comprises a base on which the pattern 7 is formed. The pattern 7 is provided on the side of the decorative layer 3 opposite the resin layer 2 and hence can comprise pictures, patterns, trademarks and alike or it may be mere coloring of the surface of the decorative layer 3 and may be partial or entire coloring of the surface of the decorative layer 3. Further, the pattern 7 may be formed in a single color or a plurality of different colors.

As the decorative layer 3 with the pattern 7 may be used a paper or resin sheet with the pattern 7 provided by a printing or electrophotographic process. Such a paper sheet as the base with the pattern 7 provided thereon, is suitably capable of being uniformly impregnated with resin from the resin layer 2 to provide enhanced integrity with the resin layer 2. Likewise, the resin sheet noted above suitably has high affinity to the resin in the resin layer 2. If the base is resin-permeable, it is possible for air bubbles present in the resin layer 2 to pass through the base to the pre-preg layer 4 and thus it is possible to obtain an effect of purging air bubbles through the pre-preg layer 4 to the outside.

The paper or resin sheet as the base of the decorative layer 3 is further suitably capable of becoming transparent when permeated by resin from the resin layer 2. In this case, the pattern 7 of the decorative layer 3 looks like floating with the transparent base as background, and thus it is possible to provide more excellent aesthetic sense to the appearance of the molding. Examples of such base are thin paper sheets or non-woven cloths of thermoplastic resins such as nylon and PET having thicknesses of between approximately 10 μm and 100 μm. The ink used for the pattern 7 is selected to suitably free from deterioration and fading by heat provided when hardening the pre-preg to obtain a molding.

If it is desired to conceal the color of the usual pre-preg materials with the hybrid pre-preg 1 laminated thereon even with sacrifice in the transparency due to providing permeability within the resin in the base of the decorative layer 3, then a base may be used such as a paper sheet containing TiO2 or like pigment having a concealing ability with respect to the color of the ground or a sheet of an opaque resin. The thickness of the decorative layer 3 is generally between 5 μm and 500 μm, and more typically between 10 μm and 300 μm. It would also be evident that the pre-preg layer 4 has a role of protecting the inner decorative layer 3 since it is transparent to let the pattern 7 of the decorative layer 3 be seen from the outer side of the pre-preg layer 4. As such pre-preg layer 4 may be implemented using a transparent pre-preg comprising transparent reinforcement fibers and a matrix resin.

Examples of such transparent fibers include but are not limited to glass fibers, alumina fibers and quartz fibers. These transparent fibers may be used alone, or a plurality of different transparent fibers may be used in hybrid combination and may further be used in the form of uni-directional arrangement or in the forms of cloth or mat. In the case of the use of transparent fibers in the form of cloth or mat, it is possible to use a plurality of pieces of cloth or mat by laminating these pieces such that fibers overlap in the same direction or by laminating these pieces in hybrid combination such that the fibers overlap in an inclined fashion.

As a general rule, common thermosetting resins such as epoxy resins may be used as the matrix resin although from the standpoint of providing the transparency of the pre-preg layer 4, however, resins lacking transparency are not used. The thickness of the transparent pre-preg layer 4 is generally between 10 μm to 200 μm, and typically between 50 μm and 100 μm. The amount of the transparent fibers in the transparent pre-preg layer 4 per unit area thereof is typically between 30 g/m2 and 200 g/m2 with the amount of the matrix resin in the pre-preg layer 4 is generally between 20% to 80% by weight, more typically between 30% to 75% by weight.

The total thickness of the hybrid laminated pre-preg 1 is generally between 50 μm and 500 μm. If the thickness of the hybrid pre-preg 1 is less than 50 μm then generally it is too thin and makes it difficult to produce the pre-preg 1. In addition, such thin pre-preg layers are generally impractical for producing fiber reinforced composite resin material moldings. Similarly if the thickness exceeds 500 μm then it is generally difficult to produce fiber reinforced composite resin material moldings with satisfactory moldability. The hybrid laminated pre-preg 1 may be manufactured with many different process flows. One such process flow being that a resin-coated paper is stacked a paper or like sheet with printed pattern 7 such that the pattern 7 is on the side opposite the resin layer, and a transparent pre-preg is then stacked on the paper or like sheet. This stack is then pressed with a thermal press from the outside of the support of the transparent pre-preg and the resin-coated paper, thus integrating the resin of the resin-coated sheet, the paper or like sheet with the pattern 7 and the transparent pre-preg.

Alternatively, in case of manufacturing the transparent pre-preg by pressing transparent fibers stacked on the resin-coated paper with a thermal press, transparent fibers are arranged on the paper or like sheet with the pattern 7 stacked on an another resin-coated paper, the above resin-coated paper for the transparent pre-preg is then stacked on the arranged fibers, and the stack is pressed from the outer side of the outer and inner resin-coated papers with a thermal press. In this way, it is possible to manufacture the hybrid laminated pre-preg by forming the transparent pre-preg from the resin of the outer resin-coated paper and the transparent fibers while also integrating the transparent pre-preg, the paper or like sheet with the printed pattern 7 and the resin of the lower resin-coated paper.

In the manufacture of fiber reinforced composite resin material moldings, the hybrid pre-preg 1 is usually used in combination with other pre-pregs such as carbon fiber pre-preg for example. For example, in a golf club shaft, which basically comprises an inner layer consisting of angle or straight layers and an outer layer consisting of straight or angle layers, the outer layer being combined with and of the opposite kind to layers of the inner layer, a couple of layers of the hybrid laminated pre-preg 1 are used with the resin layer 2 on the inner side as the outermost layer of the outer layer consisting of the angle or straight layers.

As an example, in the case of a golf club shaft, the outermost layer of which is a straight layer, usual pre-preg such as carbon fiber pre-preg is wound on a mandrel a predetermined number of turns for the angle layer with the direction of the fiber arrangement inclined with respect to the axis of the mandrel and a predetermined number of turns for the straight layer with the direction of the fiber arrangement made parallel to the mandrel axis, and when winding the straight layer the hybrid pre-preg 1 is wound a couple of turns as the outermost layer. Then, a retainer tape is wound to prevent deformation of the usual pre-preg and the hybrid laminated pre-preg 1, and in this state the matrix resin is hardened by a heat treatment. In this way, the fiber-reinforced composite resin layers of the usual pre-preg and hybrid laminated pre-preg 1 are rendered into fiber reinforced composite resin material layers, thus obtaining a hardened body having a shape of a golf shaft. Subsequently, the hardened body surface may be polished to obtain a finished golf club shaft.

A golf club shaft manufactured in this way using the hybrid laminated pre-preg 1 as in this embodiment is light in weight and has satisfactory mechanical strength. In addition, the pattern 7 of the decorative layer 3 of the hybrid laminated pre-preg 1 laminated in a single layer to a plurality of layers as the outermost layer, can be seen through the thin transparent layer of fiber reinforced composite resin material constituted by the transparent pre-preg layer 4 at the surface. In other words, the pattern 7 can be seen at the bottom of the thin transparent layer.

Further, in case when the base of the decorative layer 3 such as a thin paper or like sheet is capable of being made transparent by resin permeation, the pattern 7 of the decorative layer 3 is seen floating with the transparent base on the background, thus adding an excellent aesthetic sense to the appearance of the golf club shaft. Further, by providing the ground layer 7a of resin permeation prevention ink under the pattern 7, it is possible to eliminate adverse effects of the resin permeating the decorative layer 3 and further increase the stability of the pattern 7. Further, the decorative layer 3 is protected very firmly by the fiber reinforced composite resin material layers of the transparent pre-preg layer 4.

Referring to first cross-section 230 and second cross-section 240 these are shown each comprising four layers after the prior art of J. Meyer in U.S. Pat. No. 6,805,642 entitled “Hybrid Golf Club Shaft. First cross-section 230 comprises uniform tubular cover layer 232 and tubular core layer 234 whilst second cross-section 240 comprising shaped tubular cover layer 232 and shaped tubular core layer 244. Meyer teaches that the uniform tubular cover layer 232 and shaped tubular core layer 242 are continuous layers formed from at least one isotropic material having a Young's modulus greater than about 5 Mpsi, preferably greater than about 10 Mpsi.

The isotropic material may be a metallic material such as metal matrix composites, metals, or alloys thereof including one or more combinations of metallic constituents. Among the numerous metals that are suitable are ferrous metals such as titanium, steel, stainless steel, aluminum and tungsten are particularly useful. Additionally, certain nonferrous metals including nickel, copper, zinc, brass, bronze, magnesium, tin, gold and silver may be employed generally as alloying agents. Metal matrix composites that are quasi-isotropic may also be desirable for use. The uniform tubular core layer 234 and shaped tubular core layer 244 are taught as being formed from a non-isotropic (i.e. either anisotropic or quasi-isotropic) materials that may be in the form of particles, flakes, whiskers, continuous or discontinuous fibers, filaments, ribbons, sheets, and the like or mixtures thereof. Suitable reinforcement material include carbon fibers, graphite fibers, glass fibers, quartz fibers, boron fibers, ceramic fibers or whiskers such as alumina and silica, metal-coated fibers, ceramic-coated fibers, diamond-coated fibers, carbon nanotubes, aramid fibers such as Kevlar®, poly-phenylenebenzobisoxazole (“PEO”) fibers such as Zylon®, metal fibers, polythenes, polyacrylates, liquid crystalline polymers, and aromatic polyesters such as Vectran®.

These fibers may be coated with a metal such as titanium, nickel, copper, cobalt, gold, silver, lead, etc. The reinforcement material is impregnated within thermosetting or thermoplastic resins, serving as the matrix binder and providing vibration damping effect to the shaft. Suitable resins include epoxy; polyester; polystyrene; polyurethane; polyurea; polycarbonate; polyamide; polyimide; polyethylene; polypropylene; polyvinyl halide; nylon, liquid crystal polymer, and the like or mixtures thereof. Additionally these resins may further include modifying agents such as hardeners, catalysts, fillers, crosslinkers, etc. Meyer only teaches to shafts that are circular in keeping with the dominant commercial products and majority of the prior art. However, as Applicant there is no limitation to the cross-section when the isotropic material, forming the uniform tubular cover layer 232 and shaped tubular core layer 242, and non-isotropic material, forming the uniform tubular core layer 234 and shaped tubular core layer 244, could be cast, moulded etc with ease to other geometries.

Referring to cross-section 250 an alternate design according to Meyer is shown wherein a reinforcing layer 252, formed from an isotropic or quasi-isotropic material is disposed on the inner surface of core layer 254. This configuration in combination with intermediate layer 256 and outer layer 258 form classic strained layer vibration damping systems that effectively dissipate the mechanical energy in the shaft resulting from striking the golf ball. The reinforcing layer 252 may be continuous or discontinuous, porous or nonporous, similar in construction and/or material composition to cover layer 258 or intermediate layer 256. Alternatively, reinforcing layer 252 may be one or more discrete elements placed at predetermined locations on the shaft to achieve specific objectives, such as weight adjustment, structural reinforcement, stiffness modification, or kick point adjustment, among others.

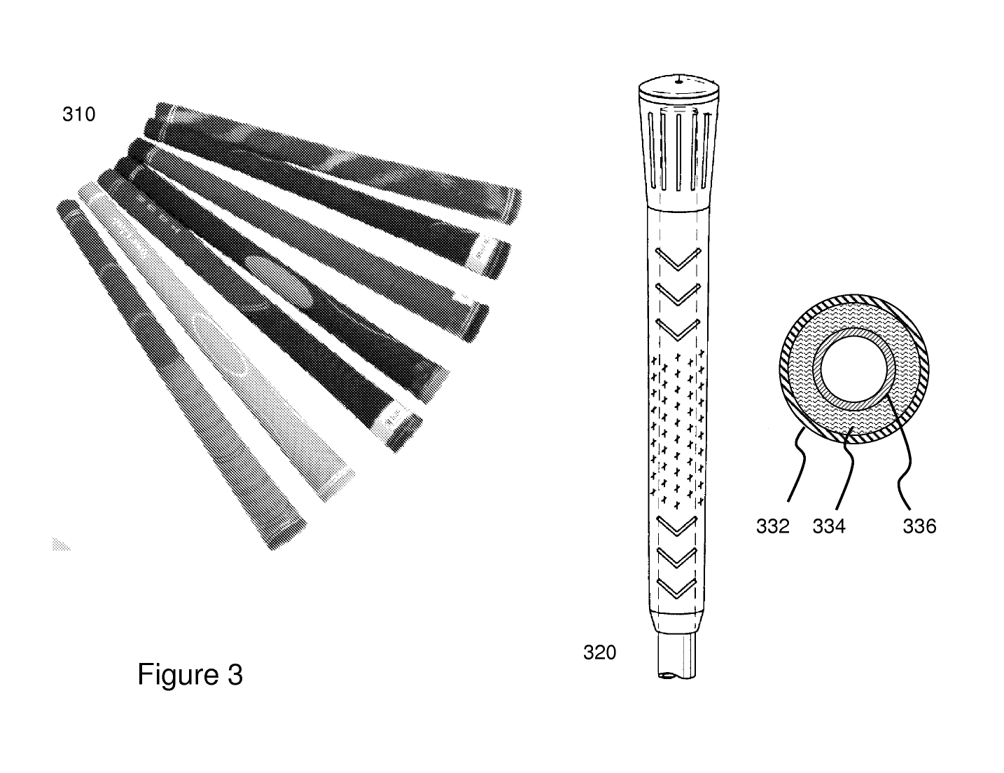

Now referring to FIG. 3 there are shown golf grips 310 in a variety of designs. Whilst golf clubs as shown from FIG. 1 are offered in a large variety of designs by multiple manufacturers the range of grips is even larger as they include not only material and structural design variations but also cosmetic factors of colour, design, etc. alongside size to account for the variations in golfers hands. Referring to grip 320 there is shown a golf club grip according to the prior art of F, Manual et al in U.S. Pat. No. 6,656,057 entitled “Golf Club Grip.” As such the grip 320 comprises a tubular foam body 334 that is sleeved around the golf club shaft 336 and has an anti-slip skin 332 bonded or laminated integrally to and covering the tubular foam body 334. The grip 320 is tapered and has a substantially bulbous shape, an open end to allow it to be slipped over the golf club shaft 336 and a closed end covering the butt end of the golf club shaft 336 with a vent hole. As the grip of the club is an extremely important part of the golfers' ability to achieve the desired stroke designs of the grip 320 vary with differing suitability to individuals. In other instances the grip 320 is moulded to include guides for the golfers' fingers, thumbs and may be moulded to their hands. In such instances the orientation of the grip 320 to the golf club shaft is extremely important as that will then define the orientation of the golfers' hands to the face of the club. This is even more evident when one considers that the face angle of an offset driver such as the M80 SuperSpeed Fairway Woods is only 2°.

Now referring to FIG. 4A there is depicted a golf club assembly in side section view 410 and front section view 420 according to an embodiment of the invention wherein a golf club hosel 450 and shaft 430 are aligned through their mating interfaces, and the golf club hosel 450 is connected to the club face 440. As is evident the shaft 430 is comprised a body 430A of circular geometry 430A and taper 430B of variable quadrilateral cross-section. As shown the taper 430B fits within the golf club hosel 450 which having a corresponding recess of variable quadrilateral cross-section will receive the taper 430B in only one orientation. Also shown are first and second cross-sections X-X and Y-Y through the side section view 410 showing the engagement of the taper 430B and golf club hosel 450.

Referring to FIG. 4B there is depicted a golf club assembly 470 in cross-section according to an embodiment of the invention wherein a golf club shaft 430 and grip 460 are aligned through their mating interfaces. The shaft 430 is comprised a body 430A of circular geometry 430A and taper 430B of variable quadrilateral cross-section wherein the shaft 430 when inserted into the recess within the grip 460 so that the shaft 430 and grip 460 are aligned in predetermined manner. Also shown are first and second cross-sections X-X and Y-Y through the golf club assembly 470.

It would be apparent to one skilled in the art that other combinations of structures on the golf club hosel, golf club shaft ends, and golf club grip may be employed to achieve the desired predetermined angular orientation between the golf club hosel and golf club shaft and/or golf club shaft and golf club grip. Optionally, such structures may allow only one assembly orientation or they may allow multiple orientations but these are at predetermined angles between an axis of the golf club hosel and/or golf club grip and an axis or axes of the golf club shaft.

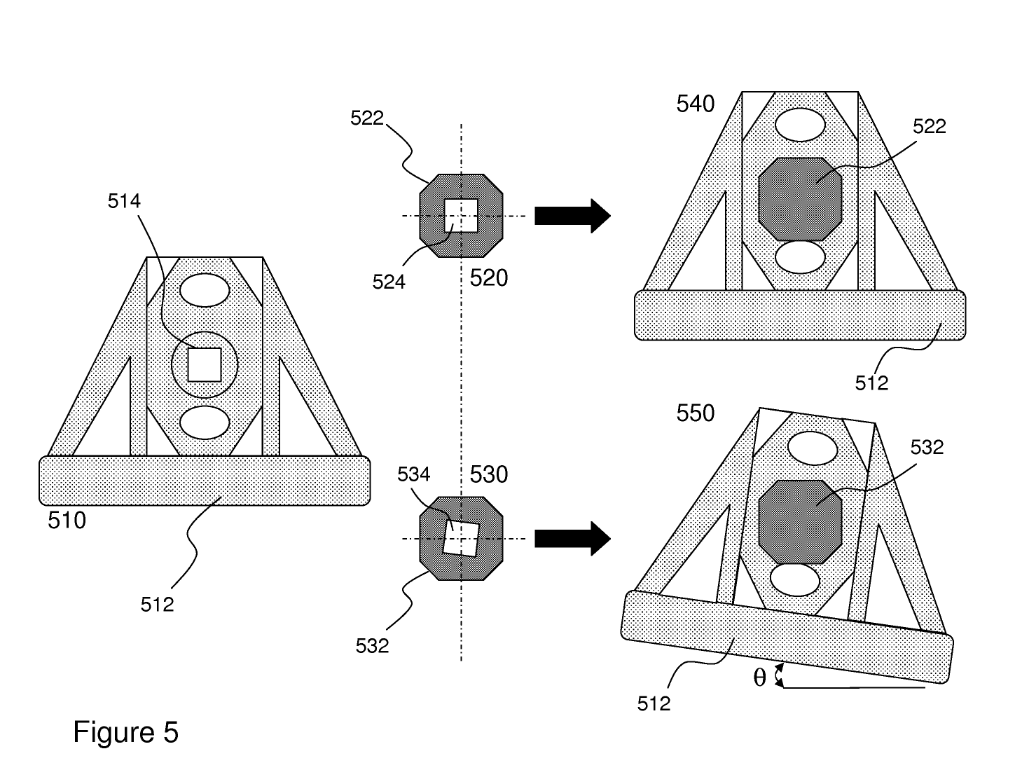

Referring to FIG. 5 there is depicted an embodiment of the invention wherein a golf club face angle is adjusted with replacement of the shaft in conjunction with a golf club head 510 of a standard external geometry 512 with a hosel recess 514 of square cross-section. First golf club shaft 520 comprises first body 522 of octagonal cross-section (for ease of detecting rotational changes in the depiction of embodiments) and first square end 524. Accordingly when first square end 524 is inserted into the hosel recess 514 the resulting first assembly 540 results wherein the first body 522 and standard external geometry 512 are aligned. Second golf club shaft 530 comprises second body 532 of octagonal cross-section (for ease of detecting rotational changes in the depiction of embodiments) and second square end 524. Accordingly when second square end 524 is inserted into the hosel recess 514 the resulting second assembly 540 results wherein the second body 522 and standard external geometry 512 are now aligned with a predetermined rotational offset, θ.

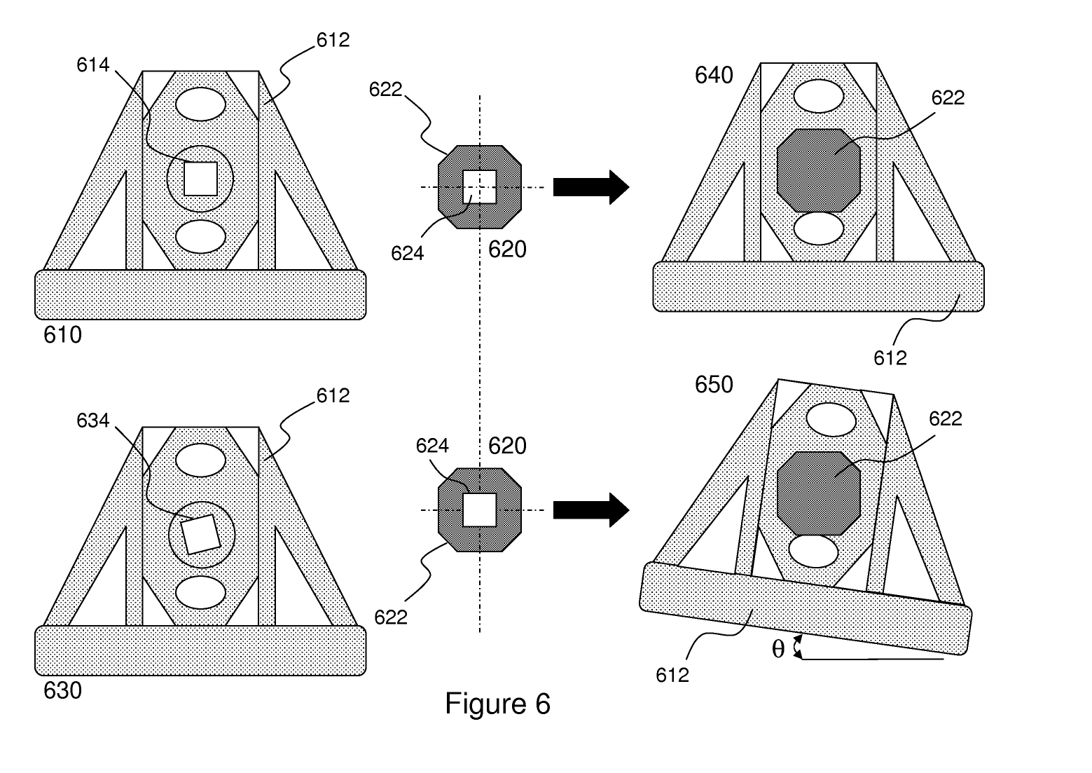

Now referring to FIG. 6 there are depicted embodiments of the invention wherein a golf club face angle is adjusted with a variation in the golf club head with respect to a golf club shaft of standard external geometry. First golf club head 610 of a standard external geometry 612 has a first hosel recess 614 of square cross-section. Golf club shaft 620 comprises first body 622 of octagonal cross-section (for ease of detecting rotational changes in the depiction of embodiments) and square end 624. Accordingly when square end 624 is inserted into the first hosel recess 614 the resulting first assembly 640 results wherein the first body 622 and standard external geometry 612 are aligned. Second golf club head of a standard external geometry 613 has second hosel recess 634 of square geometry but rotated with respect to the standard external geometry 612. Accordingly when square end 624 is inserted into the second hosel recess 634 the resulting second assembly 650 results wherein the body 622 and standard external geometry 612 are now aligned with a predetermined rotational offset, θ.

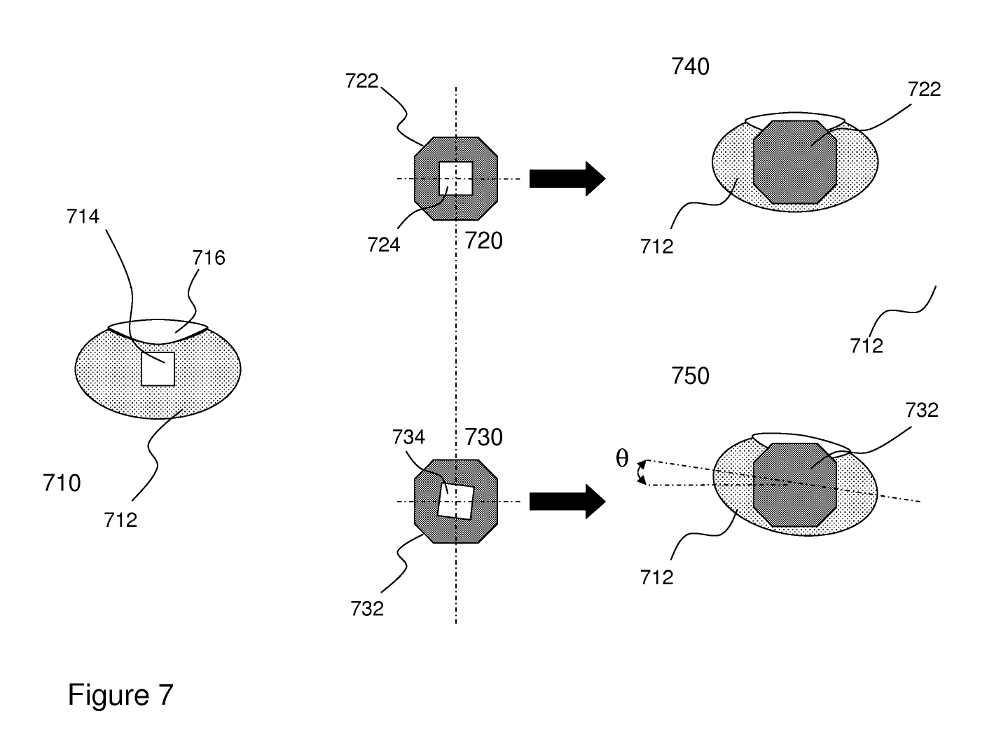

Referring to FIG. 7 there is depicted an embodiment of the invention wherein a golf club grip orientation is adjusted with replacement of the shaft in conjunction with a golf club grip 710 of an elliptical geometry 712 with finger grip 716 and hosel recess 714 of square cross-section. First golf club shaft 720 comprises first body 722 of octagonal cross-section (for ease of detecting rotational changes in the depiction of embodiments) and first square end 724. Accordingly when first square end 724 is inserted into the hosel recess 714 the resulting first assembly 740 results wherein the first body 722 and elliptical geometry 712 are aligned. Second golf club shaft 730 comprises second body 732 of octagonal cross-section (for ease of detecting rotational changes in the depiction of embodiments) and second square end 724. Accordingly when second square end 724 is inserted into the hosel recess 714 the resulting second assembly 750 results wherein the second body 732 and elliptical geometry 712 are now aligned with a predetermined rotational offset, θ.

As depicted in FIG. 7 the golf club grip 710 is depicted as essentially fitting onto the end of the golf club shaft 720 wherein the interface is over the length of the square end of the golf club shaft and hosel recess 714. However, it would be apparent that the hosel recess may be provided at a predetermined point along the length of the grip from the end closest to the club head and the second distal end of the golf club grip with another recess allowing the golf club shaft to fit within such that the grip sits over a predetermined length of the golf club shaft but is rotationally aligned by the engagement of the hosel recess and square end of the shaft.

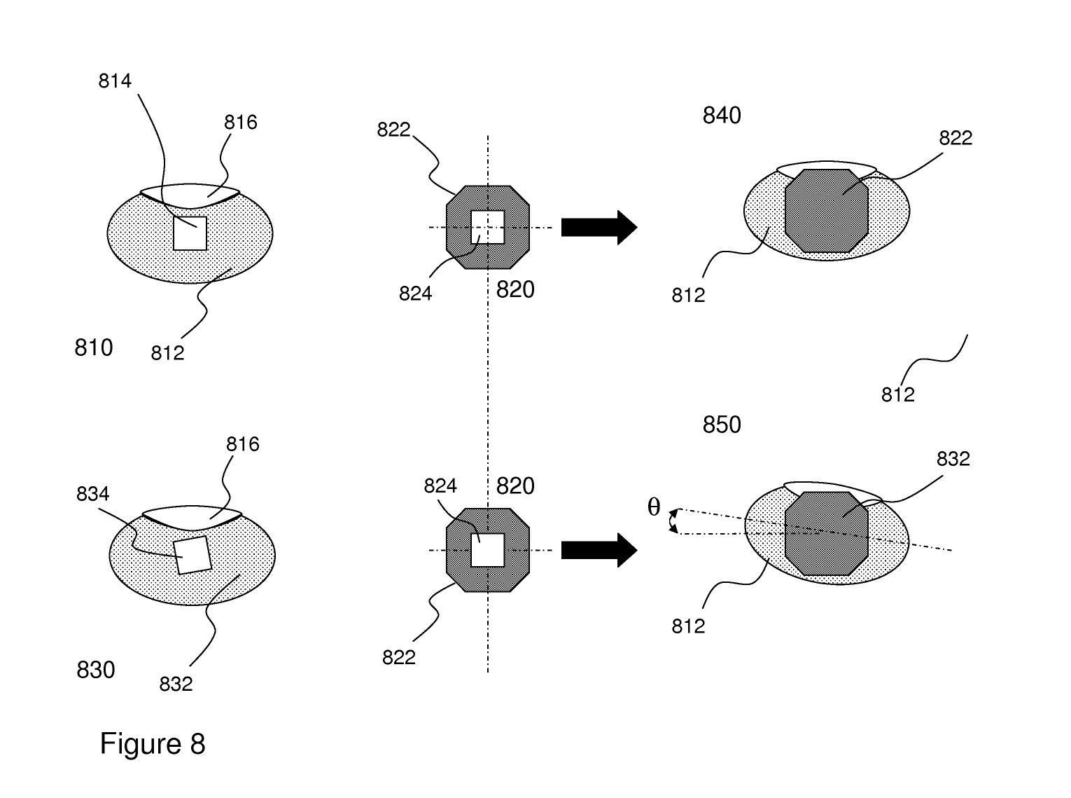

Now referring to FIG. 8 there are depicted embodiments of the invention wherein a golf club grip orientation is adjusted with a variation in the golf club grip with respect to a golf club shaft of standard external geometry. First golf club grip 810 comprises an elliptical geometry 812 with finger grip 814 and first hosel recess 814 of square cross-section. Golf club shaft 820 comprises first body 822 of octagonal cross-section (for ease of detecting rotational changes in the depiction of embodiments) and square end 824. Accordingly when square end 824 is inserted into the first hosel recess 814 the resulting first assembly 840 results wherein the first body 822 and standard external geometry 812 are aligned. Second golf club grip of elliptical geometry 832 has finger grip 816 and second hosel recess 834 of square geometry but rotated with respect to the elliptical geometry 832. Accordingly when square end 824 is inserted into the second hosel recess 834 the resulting second assembly 850 results wherein the body 822 and elliptical geometry 812 are now aligned with a predetermined rotational offset, θ.

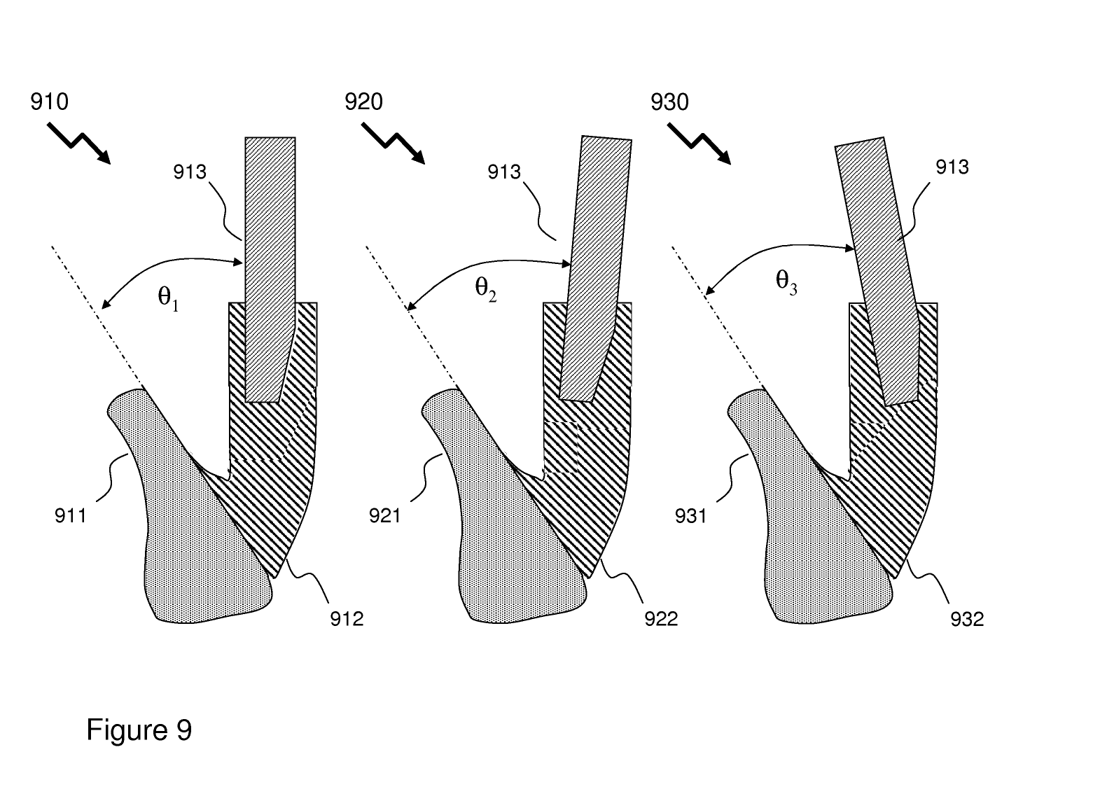

Referring to FIG. 9 there is depicted an embodiment of the invention wherein golf club loft angle is adjusted with replacement of the golf club head with a golf club shaft 913 of a standard external geometry such as described previously in respect of golf club shaft 430 in FIG. 4A with circular main body and taper of variable quadrilateral cross-section. In first cross-section 910 the golf club shaft 913 is inserted to a matching variable quadrilateral cross-section recess within first hosel 912 to which is attached first head 911. As such the face of the head 911 is offset by first angle θ₁ with respect to golf club shaft 913. In second cross-section 920 the golf club shaft 913 is inserted to a matching variable quadrilateral cross-section recess within second hosel 922 to which is attached second head 921. As such the face of the second head 921 is offset by second angle θ₂ with respect to golf club shaft 913. In third cross-section 930 the golf club shaft 913 is inserted to a matching variable quadrilateral cross-section recess within third hosel 922 to which is attached third head 921. As such the face of the third head 921 is offset by third angle θ₃ with respect to golf club shaft 913.

It would be evident to one skilled in the art that the above described embodiments of adjust the loft angle of a golf club face may be implemented with a wide range of varying configurations and structures for the golf club hosel and end of the golf club shaft without departing from the scope of the invention.

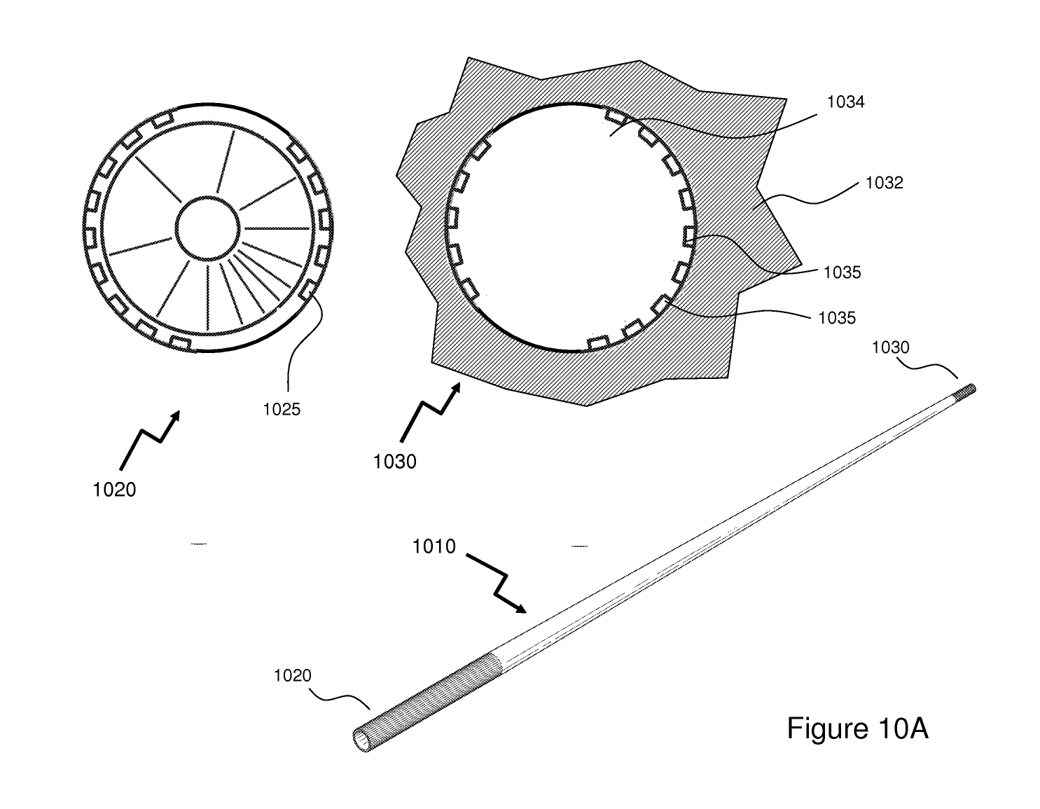

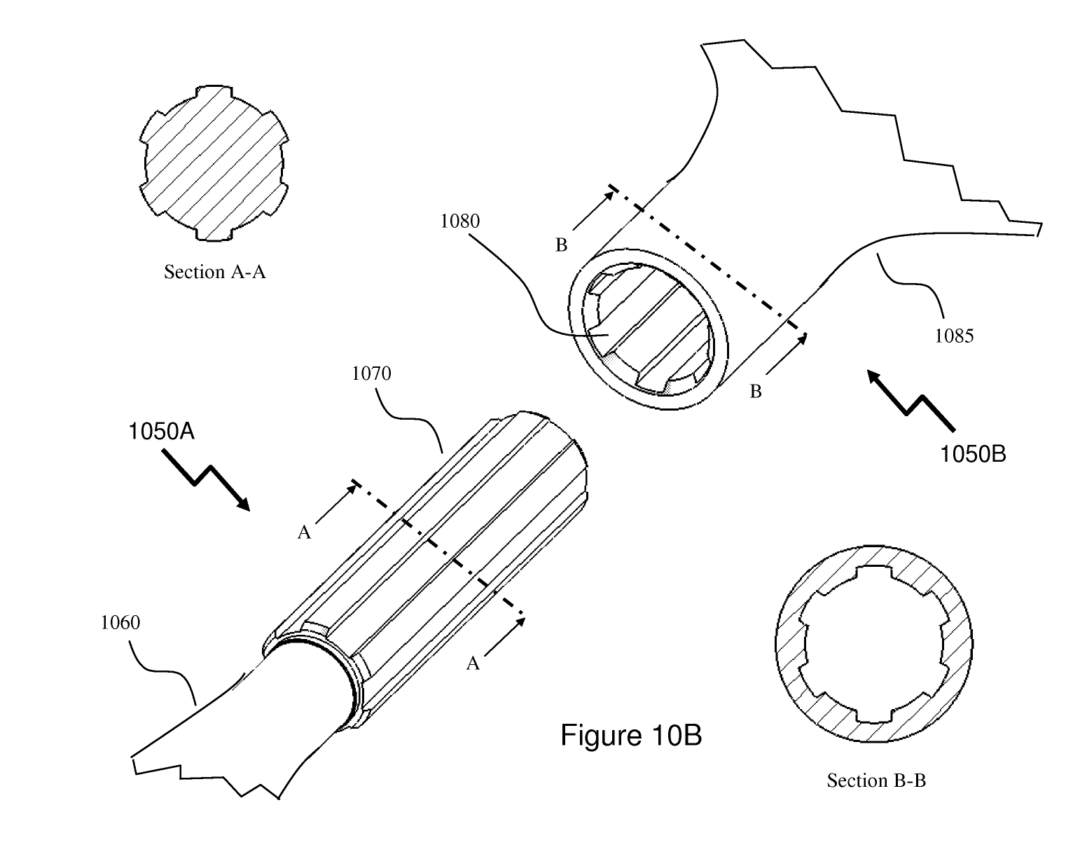

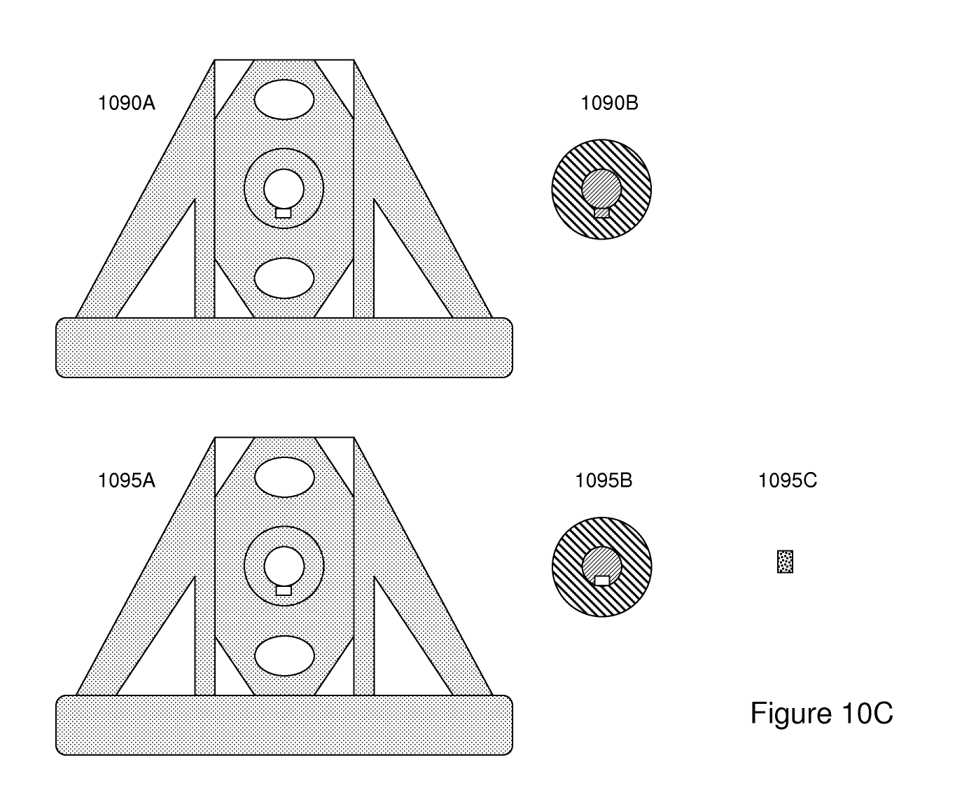

In the embodiments described supra the recess/member have been discussed as being of relatively simple cross sectional design. It would be apparent to one of skill in the art that alternative designs exist that have increased complexity such as the interface shown in FIG. 10A wherein a golf club shaft 1010 is depicted with grip engagement 1030 and hosel engagement 1020. As evident from the end-elevation view of hosel engagement 1020 the shaft has a circular tapering geometry and a series of grooves, being 5 on the right hand side (RHS) and 9 on the left hand side (LHS). Hosel portion 1030 comprises a hosel body 1032 within which a hosel recess 1034 has been formed which has a series of splines 1035, being 9 on the RHS and 5 on the RHS. Accordingly the hosel engagement 1020 can only engage the hosel recess 1034 within the hosel body 1032 in a single orientation such that the golf club shaft 1010 is aligned in predetermined manner to the hosel body 1032 and the golf club of which it forms part, not shown for clarity. It would be evident that a similar construction may be provided for the grip engagement 1030 and the inner surface of the grip recess, not shown for clarity such that by the relative locations of the splines and recesses at either end the grip and hosel, and therein golf club head, are aligned in a predetermined manner.

Referring to FIG. 110B a similar spline-rib interface for a golf club shaft to a golf club hosel and/or golf club shaft grip is shown wherein the member 1070 formed at the end of the shaft 1060 of the first element 1050A has a generally circular cross-section with ribs as evident from first cross-section A-A. Similarly, the recess 1080 formed within the hosel 1085 of the second element 1050B has corresponding circular cross section with grooves to match the locations of the ribs as evident from second cross-section B-B.

Referring to FIG. 10C there are depicted variations of the geometry between the mating portions of the hosel on a golf club and the shaft according to embodiments of the invention. First club head 1090A has a circular hosel recess with a rectangular notch whilst first shaft 1090B that has circular projection with a rectangular projection such that these elements correspond in profiles such that first club head 1090A aligns to first shaft 1090B in predetermined angular relationship. Also depicted are second club head 1095A has a circular hosel recess with a rectangular notch whilst first shaft 1095B that has circular projection with a rectangular notch a well such that these elements correspond in profiles. When the first club head 1095A has first shaft 1095B inserted into the hosel recess then they can be fixed in predetermined angular relationship through the use of tapered pin 1095C. It would be evident that a variety of other mating designs may be employed with or without additional means to fix the parts in alignment.

It would be evident to one skilled in the art that the structures provided on the golf club shaft in order to maintain engagement within the hosel may exploit mechanical interference or soldering for example. The latter being through for example the use of low temperature solders such as Indalloy 165 (ASTM 1.5S) or Pb₉₀ Sn₁₀ for example allowing the parts to be soldered in place as an alternative to the conventional epoxy construction. It would also be apparent that the same principle may be employed in attaching the grip/hosel and shaft together as well as conventional methods based upon adhesives, tapes, epoxies, resins, etc.

It would also be apparent that a variety of attachment means can be employed for the golf club hosel to the golf club shaft and/or golf club shaft to golf club grip including but not limited to solder, resins, epoxies, cyanoacrylate adhesives, mechanical interference fits, bolts and threaded inserts. For example first element 1050A may have a threaded insert in the end of the member 1070 such that a bolt inserted through the base of the golf club shaft into recess 1080 of second element 1050B may be tightened to lock the golf club shaft and golf club head together whilst angular alignment is maintained through the action of the ribs/recesses. Alternatively, a solder or epoxy may be employed.

It would be evident to one skilled in the art that the embodiments described supra in respect of FIGS. 4A through 10 have been discussed in terms of the golf club shaft have projecting members that engage recesses within the golf club grip and hosel of the golf club head. It would be apparent that optionally the recess or recesses may in fact be on the golf club shaft such that the projecting member is on either the golf club hosel or golf club grip or both. It would be apparent that the depth/length of the recess/projection may be established in dependence upon whether the elements are golf club head/shaft or shaft/grip for example as well as the accuracy of alignment desired between the elements.

It would be evident to one skilled in the art that the methods of manufacturing described above can support integration of such recesses directly or by incorporating an additional element into the design to which the golf club shafts described above in respect of FIGS. 4A through 10 are integrated during the manufacturing process. One such example being shown in FIG. 1D in cross-section 142 with solid insert 25. It would be evident to one of skill in the art that the number of splines/grooves, their location, relative dimensions etc. and thereby the corresponding grooves/splines may be varied according to the design and manufacturing requirements of the manufacturer that may be determined by factors including but not limited to the target cost of the club, angular misalignment error acceptable, and material selection for the golf club shaft.

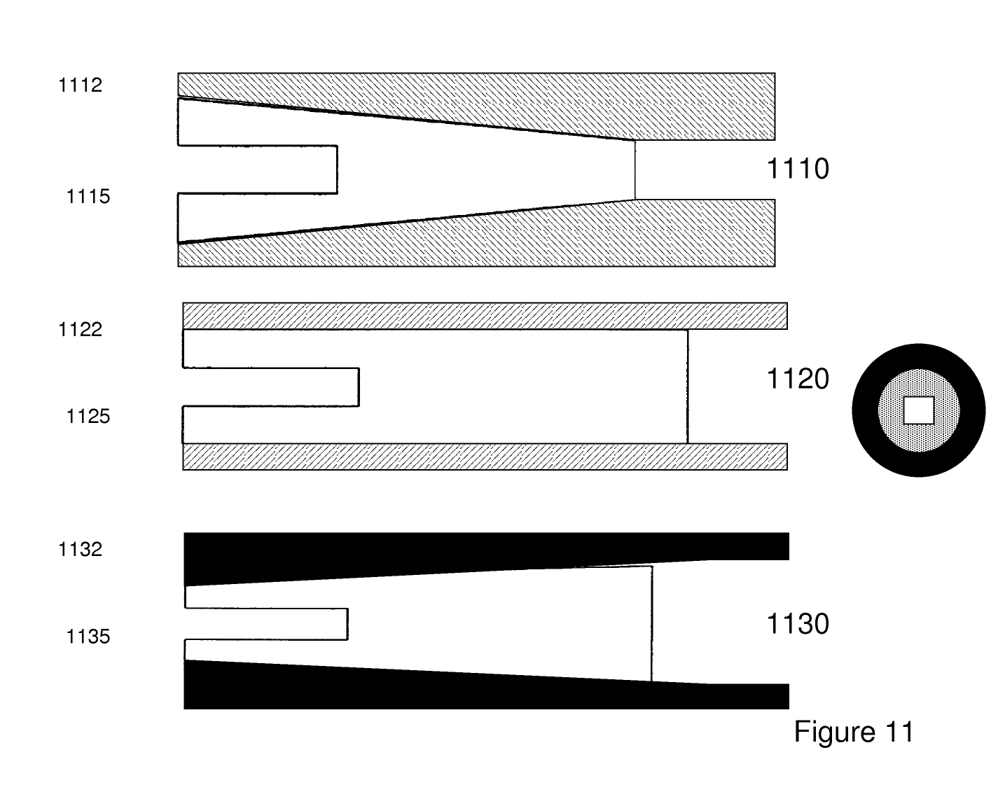

Referring to FIG. 11 there are shown first to third golf club shaft ends 1110 to 1130 respectively. First golf club end 1110 comprising first club shaft 1112 and first insert 1115 wherein the first club shaft 1112 and first insert 1115 have inner and outer surfaces that are tapering with reducing diameter for first insert 1115 away from the end of the first golf club shaft 1112. Second golf club end 1120 comprising second club shaft 1122 and second insert 1125 wherein the second club shaft 1122 and second insert 1125 have inner and outer surfaces that are of constant diameter away from the end of the second golf club shaft 1122. Likewise, third golf club end 1130 comprising third club shaft 1132 and third insert 1135 wherein the third club shaft 1132 and third insert 1135 have inner and outer surfaces that are of increasing diameter for the third insert 1135 away from the end of the third golf club shaft 1132. Each of first to third inserts 1115 through 1135 respectively may have a recess for accepting the fitting of the grip or golf club head hosel that correspond to designs described above in respect of FIGS. 4A through 10 and be integrated within a manufacturing flow such as depicted supra in respect of FIGS. 1A through 1F.

It would be evident to one skilled in the art that according to the particular manufacturing process employed the dimensions of the golf club shaft, insert, etc. that the insert may be placed into the appropriate position during the manufacturing process of the golf club shaft or inserted after the golf club shaft has been manufactured partially or completely. It would also be apparent that optionally in some circumstances the recess or projecting member on the golf club shaft that engages the golf club hosel and/or golf club grip may be machined after the manufacturing process for the golf club shaft should such a final manufacturing step result in improved manufacturing tolerances between an axis of the golf club shaft, such as when manufacturing a non-circular shaft as described supra, and an axis of the recess/projecting member.

As is evident from the embodiments described above in respect of FIG. 1F the golf club shaft itself may vary in geometry and provide either keying to a golf club head hosel or grip in a single alignment or multiple alignments according to the particular design implemented. It would also be evident that the aligned interface between a golf club shaft and the golf club head hosel or golf club grip allows the requirement in some designs for epoxy, resin, tape or other materials to prevent rotation as now rotation is mechanically prevented unlike prior art approaches. Whilst epoxy, resin, tape or other materials may be employed to secure the elements of the golf club to one another, as well as other methods such as mechanical interference, solder, mechanical fixtures etc., the requirements for these may now be considered differently as their primary consideration is towards longitudinal sheer between the elements rather than the inducement of high rotation sheer for example as the golf club head impacts the golf ball twisting the head relative to the shaft or the golfer starts their swing.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
providing a component comprising a shaft of length substantially larger than its lateral dimensions, the shaft having a predetermined cross section, the shaft terminating at a first end to which a golf club head will be assembled with a member comprising at least a first surface and a second surface, and terminating at a second distal end to which a golf club grip will be assembled with second member comprising at least a third surface and a fourth surface;
wherein at least the first and third surfaces are aligned angularly in a predetermined relationship with respect to an axis of the component.

2. The method of claim 1 wherein,
the first surface has a geometry substantially that of a predetermined portion of a member that forms part of one of a golf club head hosel and a golf club shaft grip; and
the second surface has a geometry substantially that of a predetermined portion of a member that forms part of the other a golf club head hosel and a golf club shaft grip.

3. The method of claim 2 wherein,
engagement of the shaft, golf club head hosel and golf club grip results in predetermined angular orientation of a strike face of the golf club head to an aspect of the grip.

4. The method of claim 1 wherein,
at least one of the first member and second member have a predetermined cross-section the predetermined cross section is at least one of a predetermined portion of a regular polygon, semi-circular, elliptical, and truncated circular profile.

5. The method of claim 1 further comprising,
an insert of which a predetermined portion comprises at least one of the first member and second member, wherein the member is assembled with the main body of the shaft at least one of during and subsequent to the manufacturing of the main body of the shaft.

6. The method of claim 1 wherein;
the shaft is formed from at least a first material selected from the group comprising carbon, titanium, boron, tungsten, glass fiber, steel, stainless steel, iron, resin, a plastic in sheet form, aramid synthetic fibers, epoxy, a thermoplastic, a thermosetting resin, and a wax.

7. The method of claim 6 wherein,
the shaft is formed from a plurality of layers containing fibers of the first material, wherein at least a pair of adjacent layers within the plurality of layers have the fibers orientated at different angular orientations to the longitudinal axis of the shaft.

8. The method of claim 1 wherein,
the shaft is manufactured by at least one of a molding process, a hydroforming process, and a process employing a mandrel to form the shaft upon.

9. The method of claim 1 wherein,
each of the first and third surfaces is orientated with a predetermined angular orientation to an axis of the shaft wherein the shaft has a non-circular cross section.

10. A device comprising:
a component comprising a shaft of length substantially larger than its lateral dimensions, the shaft having a predetermined cross section, the shaft terminating at a first end to which a golf club head will be assembled with a member comprising at least a first surface and a second surface, and terminating at a second distal end to which a golf club grip will be assembled with second member comprising at least a third surface and a fourth surface;
wherein at least the first and third surfaces are aligned angularly in a predetermined relationship with respect to an axis of the component.

11. The method of claim 10 wherein,
the first surface has a geometry substantially that of a predetermined portion of a member that forms part of one of a golf club head hosel and a golf club shaft grip; and
the second surface has a geometry substantially that of a predetermined portion of a member that forms part of the other a golf club head hosel and a golf club shaft grip.

12. The method of claim 11 wherein,
engagement of the shaft, golf club head hosel and golf club grip results in predetermined angular orientation of a strike face of the golf club head to an aspect of the grip.

13. The method of claim 10 wherein,
at least one of the first member and second member have a predetermined cross-section the predetermined cross section is at least one of a predetermined portion of a regular polygon, semi-circular, elliptical, and truncated circular profile.

14. The method of claim 10 further comprising,
an insert of which a predetermined portion comprises at least one of the first member and second member, wherein the member is assembled with the main body of the shaft at least one of during and subsequent to the manufacturing of the main body of the shaft.

15. The method of claim 10 wherein;
the shaft is formed from at least a first material selected from the group comprising carbon, titanium, boron, tungsten, glass fiber, steel, stainless steel, iron, resin, a plastic in sheet form, aramid synthetic fibers, epoxy, a thermoplastic, a thermosetting resin, and a wax.

16. The method of claim 15 wherein,
the shaft is formed from a plurality of layers containing fibers of the first material, wherein at least a pair of adjacent layers within the plurality of layers have the fibers orientated at different angular orientations to the longitudinal axis of the shaft.

17. The method of claim 10 wherein,
the shaft is manufactured by at least one of a molding process, a hydroforming process, and a process employing a mandrel to form the shaft upon.

18. The method of claim 10 wherein,
each of the first and third surfaces is orientated with a predetermined angular orientation to an axis of the shaft wherein the shaft has a non-circular cross section.
